(19) United States
(12) Patent Application Publication
(10) Pub. No.: US 2011/0187711 A1
(43) Pub. Date: Aug. 4, 2011

(54) Presenting Series Information in a Three-Dimensional Landscape

(75) Inventors: Andrew Giovinazzi, Bath, ME (US); James Thomas Albamont, JR., Houston, TX (US); Sean Andrew Spicer, Katy, TX (US)

(73) Assignee: AQUMIN LLC, Houston, TX (US)

(21) Appl. No.: 13/018,915

(22) Filed: Feb. 1, 2011

Related U.S. Application Data
(63) Continuation-in-part of application No. 13/010,613, filed on Jan. 20, 2011.
(60) Provisional application No. 61/300,157, filed on Feb. 1, 2010.
(60) Provisional application No. 61/356,859, filed on Jun. 21, 2010.

(51) Int. Cl. G06T 17/00

(52) U.S. Cl. 345/419

(57) ABSTRACT

Systems, methods, and software for efficiently presenting information in a three-dimensional landscape are described. In some aspects, values for multiple series of data points are received. The data points may relate to financial instruments or business intelligence metrics. A three-dimensional landscape of the values is generated. The three-dimensional landscape includes arrays of discrete graphical elements, where each array corresponds to one of the series. Each discrete graphical element has a visual attribute that represents one of the observed market values. The elements in each array are distributed along a first dimension of the three-dimensional landscape and positioned adjacent to one another to allow visual identification of trends within each series. The arrays are spaced apart from each other in a second dimension of the three-dimensional landscape to allow visual comparison of the trends across different series. The three-dimensional landscape can be updated in real time based on updated market values.

### CROSS-REFERENCE TO RELATED APPLICATIONS

This application is a continuation-in-part application of U.S. application Ser. No. 13/010,613, entitled “Presenting Financial Information in a Three-Dimensional Landscape,” filed on Jan. 20, 2011, which claims the benefit of U.S. Provisional Application No. 61/300,157, entitled “System, Method, and Software to Analyze Series-Based Financial Securities Information Across Large Numbers of Issues,” filed on Feb. 1, 2010 and U.S. Provisional Application No. 61/356,859, entitled “System, Method, and Software to Analyze Derivatives Contracts Across Large Numbers of Underlying Issues,” filed on Jun. 21, 2010. The entire disclosure of the priority applications are hereby incorporated by reference for all purposes.

### BACKGROUND

The present disclosure relates to presenting financial information in a three-dimensional landscape.

Investing in securities and other financial markets generally requires discipline, insight, and data. This data can include incredibly large amounts of information, numbers, and metrics for each market, segment, and individual issue. The financial industry uses several common sources for data both up to the second and historical, including: Bloomberg, Reuters, Morningstar, Standard and Poors, Edgar Online, Dun & Bradstreet, and Hoovers Online. These data sources provide raw data and other information that anyone can use—usually for a significant monthly subscription fee in the thousands of dollars.

This financial data is often provided in charts, simple graphs, and spreadsheets that present information in a two-dimensional form. But it is believed that over 80% of the human brain is dedicated to visual processing. Lack of motion and geometry (shapes) can cause information to be hidden within static, two-dimensional data. Put differently, staring at numbers in tables or simple graphs is not considered a natural way to analyze a target. Instead, humans better recognize patterns from shapes, particularly shapes in motion with color. For example, converting numbers to shapes reduces cognitive friction and naturally leads the mind to discover patterns.

To date, the financial industry has been served by large investment firms with access to powerful computers to process the copious amounts of data. Even with this access, professionals often miss critical information or other opportunities because enormous amounts of data presented using these charts, graphs, and spreadsheets stretch the limits of human cognitive ability. It becomes difficult to extract meaningful information from large volumes of data. Moreover, this 2D data is often security specific, instead of market wide. As a result, opportunities can be passed by, risk exposure underestimated, and even sophisticated investors can be left relatively helpless—not knowing what they do not know. At the extreme, the individual (or non-professional) investor ends up as a consumer of information of dubious quality—as he or she is typically out of reach from the top tier data providers.

### SUMMARY

The present disclosure relates to visually managing financial data and, more particularly, to efficiently accessing, processing, displaying, or otherwise managing financial data (e.g., bonds, equities, currencies, commodities, futures, options, swaps, etc.) via a three-dimensional landscape. For example, software can be implemented to efficiently map real-time direct and derived data about financial information, grouped by underlying security, into an interactive space, thereby enabling a user to interrogate, interpret, and analyze this information in a more productive setting.

In a general aspect, systems, methods, and software for viewing, managing, or otherwise analyzing financial information across large numbers of issues utilizing a display of related data and metrics are described. The financial information may include derivative contracts data, bond data, and information on other types of financial instruments. Examples of derivatives contract data includes real-time or end-of-day implied volatility (e.g., bid, ask, mid), options contract Greeks (e.g., delta, vega, gamma, theta, rho), implied interest rate yield information, and other data metrics. This disclosure describes techniques that facilitate the display, navigation, and interpretation of high quality derivatives data with visual identification (e.g., flagging) technology to provide an unparalleled view and analysis of securities market data. The landscape can provide a complete, contextual picture that allows the user to display several layers of information simultaneously. The techniques may utilize or facilitate customizable metrics, seamless system compatibility, and integrated portfolio tools. In some implementations, the derivatives contract landscape can allow on-the-fly changes to answer user queries in an instant.

In some aspects, observed market values for multiple sets of future financial payoffs are received. The future financial payoffs are based on derivatives contracts. A three-dimensional landscape of the observed market values is generated. The three-dimensional landscape includes groups of discrete graphical elements representing the sets of future financial payoffs. Each of the discrete graphical elements has a visual attribute that represents the observed market value for one of the future financial payoffs. The discrete graphical elements in each group are positioned in proximity to each other in the three-dimensional landscape to allow visual comparison of the observed market values for the set of future financial payoffs represented by the group.

Implementations may include one or more of the following features. The observed market value can be an implied volatility value, a bid value, an ask value, a mid value, a delta value, a vega value, a gamma value, a theta value, a rho value, an implied interest rate yield value, a trading volume value, an open interest value, or another value. Each set of future financial payoffs includes a put contract and a call contract. The derivatives contracts include at least one of futures contracts, options contracts, or swap contracts. Each of the sets of future financial payoffs corresponds to a term and to a strike price. The three-dimensional landscape indicates the terms and strike prices for each group of discrete graphical elements. Each set of future financial payoffs includes multiple different payoff positions for the corresponding term and the corresponding strike price. Each set of future financial payoffs includes a pair of opposing payoff positions. Unequal observed market values of the opposing payoff positions for a term indicate a deviation from a theory. Each group of discrete graphical elements includes a group of buildings, a height of each building represents the observed market value for one of the future financial payoffs. The three-dimensional landscape includes a longitudinal dimension representing a plurality of strike values; a latitudinal dimension representing a plurality of terms; and a vertical dimension representing a range of observed market values. A location of each building in the longitudinal and latitudinal dimensions indicates a strike value and a term for the future financial payoff represented by the building. A height of each building in the vertical dimension indicates the observed market value for the future financial payoff represented by the building. Each of the buildings has a color that indicates a second observed market value for the future financial payoff represented by the building.

In some aspects, values for multiple series of data points are received. The data points may relate to financial instruments or business intelligence metrics. A three-dimensional landscape of the values is generated. The three-dimensional landscape includes arrays of discrete graphical elements, where each array corresponds to one of the series. Each discrete graphical element has a visual attribute that represents one of the observed market values. The elements in each array are distributed along a first dimension of the three-dimensional landscape and positioned adjacent to one another to allow visual identification of trends within each series. The arrays are spaced apart from each other in a second dimension of the three-dimensional landscape to allow visual comparison of the trends across different series. The three-dimensional landscape can be updated in real time based on updated market values.

Implementations may include one or more of the following features. Each of the data points in each series corresponds to one of multiple different time points in a range of time points represented by the first dimension. Each series of data points spans the range of time points. Each of the discrete graphical elements is positioned adjacent to one or more neighboring discrete graphical elements in the array to allow visual identification of trends over time within the series. The arrays are spaced apart from each other in a second dimension of the three-dimensional landscape to allow visual comparison of the trends over time across different series. The observed market value for each data point is based on an end-of-day closing price, an intraday price, or another value for a financial contract, an equity security, and/or a debt instrument. Each series represents a time-based metric for a financial contract, an equity security and/or a debt instrument. The observed market values is a price value, an implied volatility value, a bid value, an ask value, a mid value, a delta value, a vega value, a gamma value, a theta value, a rho value, an implied interest rate yield value, or a ratio based on two or more of these values. Each series of data points relates to a single financial instrument, and the single financial instrument is a financial contract, an equity security, or a debt instrument. The financial contract is a futures contract, a derivatives contract, or a swap contract.

Additionally or alternatively, implementations may include one or more of the following features. Each graphical element is a building. A height of each building represents the observed market value for one of the data points. The three-dimensional landscape includes a longitudinal dimension representing forward month values, a latitudinal dimension representing a range of time points, and a vertical dimension representing a range of observed market values. A location of each building in the longitudinal and latitudinal dimensions indicates a forward month value and a time point value for the data point represented by the building. A height of each building in the vertical dimension indicates the observed market value for the data point represented by the building. A footprint of each building indicates a second observed market value for the data point represented by the building. The second observed market value is a trading volume or a deviation from average trading volume. Each of the buildings has a color that indicates a third observed market value for the data point represented by the building.

Additionally or alternatively, implementations may include one or more of the following features. Each of the data points in each series corresponds to one of multiple different geographic points in a range of geographic points represented by the first dimension. At least a portion of the data points are based on energy demand and/or energy consumption. The series correspond to geographical regions. Each series corresponds to a different geographical region, and the data points within each series correspond to different time points in one of the geographical regions.

The above (or similar) techniques can utilize or benefit from hundreds of different financial metrics tracked over a given time-period, many of which are unique to the financial space (equities, bonds, derivatives, futures, commodities, currency). To achieve some or all of the example techniques, systems or software can utilize, include, or implement various components such as a 3D client, fast network delivery from a remote source, data integration, (color, shape, and shading), multi-dimensional displays (1D, 2D, and 3D display), and a metric calculation engine. Various combinations of these components or modules help provide an information display that quickly presents a wealth of financial data that is easily understandable by the user. This interactive, three-dimensional display can create visual patterns from financial data that utilize the natural pattern recognition capability of the user's mind so that important information can be made to stand out. The result can be an improved workflow that can create, evaluate, and modify risk adjusted investment portfolios in seconds and at a fraction of the cost. Portfolios that match investors thinking and knowledge can be created for comparison side by side. Performance evaluation (whether historically or in a historical mode going forward) can be done to test ideas (back-testing) without the drudgery of manipulating spreadsheets by hand.

In certain configurations, the three-dimensional landscape can illustrate data and its changes in real-time utilizing different graphical elements. For example, the display may present various options contracts by underlying security and implied volatility. In this case, each building within a landscape can represent a particular option contract with its location representing the strike price and contract expire date, color representing the implied volatility, and the neighborhood representing the underlying security (such as IBM, MSFT, AAPL, XOM, etc.). Throughout a trading session, the user can watch tick-by-tick, second-by-second as the derivatives contract landscape dynamically changes to match activity across the market. In this way, the user can identify the more active or volatile contracts and then perhaps watch a linked newswire to determine the cause. Among other things, this could help the investor identify contracts that are opportunities for investment or should be left alone. Further, using these techniques, it is possible for the investor to test risk-balanced portfolios and examine them directly against the universe of investment opportunities visually and all at once. The three-dimensional landscape may allow the investor to visually discern systematic risks across a given market.

For the professional investor, one or more techniques similar to those above can facilitate rapid analysis and discovery of hidden opportunities and risks when using a three-dimensional landscape. For instance, current information indicates that there are over two hundred thousand professionals in the U.S. market who use data and software to manage portfolios on behalf of clients. As much as eighty percent of these professionals use tools such as Yahoo Finance, Google Finance or similar tools to provide data and context for critical investment decisions on behalf of their clients. Partially overlapping with this user-base, approximately thirty percent of these professionals use tools such as Factset and Bloomberg (typically at significant cost). In contrast, a three-dimensional graphical user interface and the intelligent use of cloud computing increases data-crunching capacity to the many professionals who can use it, often at a lower cost. Using web-technologies and platform-independent tools, these techniques may deliver a near-complete professional system to the professional investor.

For the individual or “enthusiast” investor, access to the same data and portfolio tools professionals use every day is made possible at a fraction of the cost in an intuitive, easy to learn system. It is believed that there are over five million non-professional, individual investors in the U.S. These investors are often enthusiasts who subscribe to one or more financial periodicals such as the Wall Street Journal, Investor's Business Daily, or The Motley Fool. They may watch financial news programs such as CNBC or FBN, and typically own or use software for managing their portfolios (E*Trade, Schwab, etc.). Much of the data come from free sources including Yahoo Finance, Google Finance, chat rooms created for investors, or even word of mouth. Some or all of the present techniques can help such investors test risk balanced portfolios and examine them directly against the universe of investment opportunities visually, all at once through the innovative visualization while (often) taking advantage of the computer graphics processing hardware on generic desktops and laptops.

The foregoing example advantages may not be present in every configuration or for every technique. While generally described as software, some or all of these aspects may be further included in respective systems or other devices for executing, implementing, or otherwise analyzing a suitable system. The details of these and other aspects and embodiments of the present disclosure are set forth in the accompanying drawings and the description below. But other features, objects, and advantages of the preferred embodiment will be apparent from the description and drawings.

### BRIEF DESCRIPTION OF THE DRAWINGS

FIG. 1 illustrates an example a 3-tier system, with data hosted on high-availability web-servers, app-servers, and rich clients interfacing over standard HTTP and HTTPS.

FIG. 1A illustrates an example deployment using a web-services data delivery architecture, which can allow interaction of clients with remote production data servers from any location with network connections.

FIG. 2 illustrates an example configuration of modules for analyzing financial information.

FIGS. 3A and 3B illustrate example web pages containing financial data.

FIG. 4 is a conceptual diagram of an example three-dimensional landscape.

FIGS. 5A, 5B, and 5C are diagrams illustrating example three-dimensional landscapes of observed market values.

FIG. 6 is a flow chart illustrating an example technique for presenting a graphical representation of financial information.

FIG. 7 is pseudo-code for an example algorithm for generating a graphical representation of financial information.

FIG. 8 is pseudo-code for an example algorithm for generating a graphical representation of financial information in a series format.

FIGS. 9A, 9B, 9C, and 9D are diagrams illustrating example three-dimensional landscapes of observed market values in series format.

FIG. 10 is a flow chart illustrating another example technique for presenting a graphical representation of financial information in series format.

### DETAILED DESCRIPTION

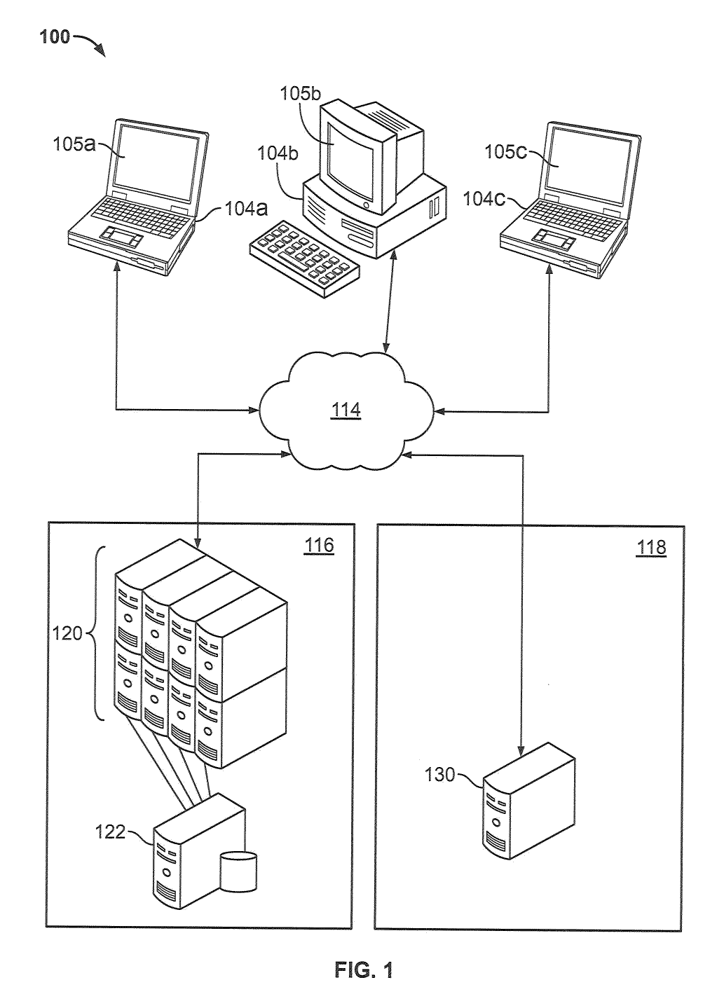

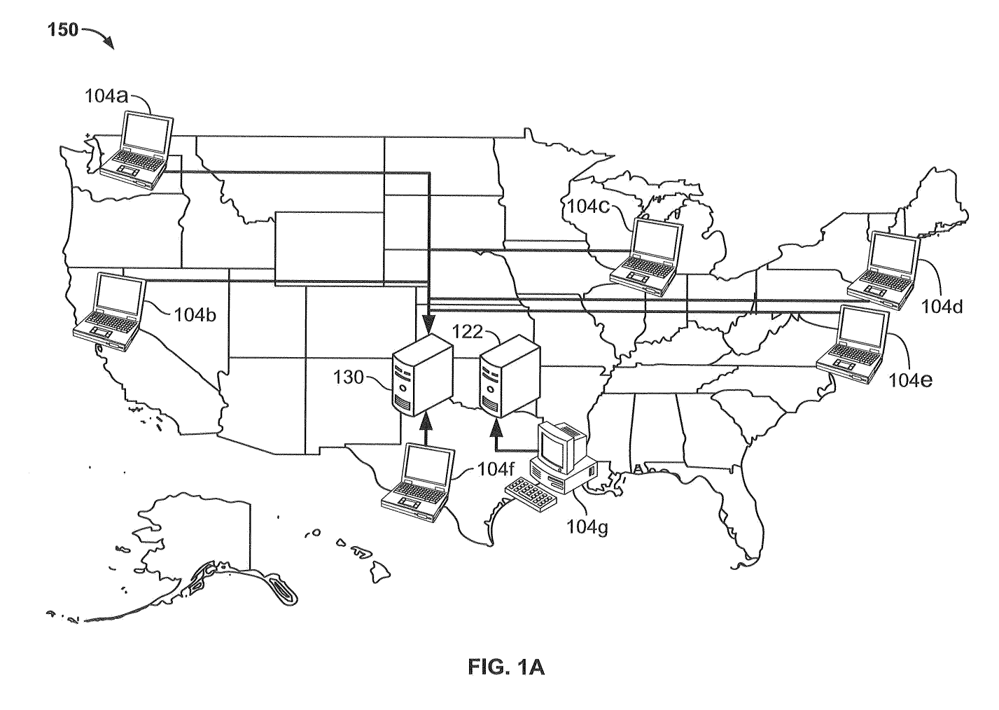

At a high level, an example financial platform implementing some or all of the techniques described herein can include a client and a backend data source, typically resident at a server or server bank as shown by FIG. 1. The client may be a thick or intelligent client that retrieves the information to satisfy a request, but without the overhead of retrieving the entire data set or the need to have a local representation of the data. Moreover, while being implemented in a thick client, the interface may use the more familiar elements of a browser. Additionally, these components allow for standardized or generic data processing and interfaces, as well as easy scalability, as opposed to a customized or in-house solution. The client implements visualization technology that creates visual patterns from data. Accordingly, important information that is hidden from view can be made to stand out when presented using interactive, multi-dimensional methods and procedures.

Fast, interactive visualization in the example systems shown and described herein may use a software “kernel” that is high performance and utilizes the high-quality visualization capability available in hardware today. A design feature of the software is ease-of-use and modularity. The software may also allow for development of custom workflows that couple traditional tools such as spreadsheets, graphs and charts into a portfolio creation and analysis tool that enables the user to glean relevance and insight from data. It is generally fast, easy to use, and more intuitive than manipulating spreadsheets by hand. The modular nature of the technology can facilitate rapid development of add-on applications that can serve several markets at once with low development cost. In addition, this architecture may easily serve customers requiring proprietary interconnections with their own software.

To facilitate the low-cost, interactive nature of the display, very large data handling over networks is another design feature of the software system. As such, the technology may be limited only by the memory of the host computer running the system and by the bandwidth of the network connection feeding data to the program. The ability to handle very large datasets interactively helps provide customers with the capability to visually analyze vast amounts of data quickly. Data throughput over networks, such as the Internet, is enhanced by minimizing the requested data set to reduce bandwidth and increase processing speed. In some instances, the data flow can be optimized by sending compressed text over HTTP (or HTTPS) instead of—or as a supplement to—over complex or congested database connections. These text connections can be quicker and more flexible than static (or hard-coded) connections, ODBC, JDBC, and so forth.

One or more aspects of the techniques described herein may be implemented at a remote data source or at the front-end client for facilitating quick financial information delivery or three-dimensional display. Specifically, such techniques may involve creating a three-dimensional graphical display space, interacting with financial information and data represented by three-dimensional objects and textures within that space, and identifying, requesting, and populating the graphic display space from a remote location over a network. Such techniques help facilitate interpretation of complex financial data sets in relative context by geographically dispersed end-users. Context may be defined by grouping of industry sector, securities exchange, asset class, contract underlie, or any other appropriate category. A user can select from any number of metrics that are mapped as “buildings” onto the three-dimensional landscape derivatives contract landscape. Three-dimensional graphical objects may take any form sufficient to convey the information contained in this underlying data, such as semi-rectangular plates overlaid with data textures. The user may interact with the system by clicking on a three-dimensional object to reveal further information detail in the form of charts, graphs, spreadsheets, textual information, web-links, or secondary three-dimensional objects. This information may be presented as an overlay layer to the map or as an element rising or falling out of the plane of the map. Upon initialization or user-selection in the graphical space, data sets used to populate the landscape are requested and transmitted to the system via HTTP (or HTTPS) web-services links, SQL database links, or other remote data population methods.

In some implementations, data elements are efficiently retrieved for an entire market-set at once in a single request, as opposed to one request per-issue as is typical of other solutions. For example, rather than requesting the daily trading volume over the last year for options contracts over IBM, then for Cisco, then for ExxonMobil and integrating these, the disclosed software can make a request to return the daily trading volume for every company in the US Market, which includes, IBM, Cisco, and ExxonMobil, or a select group, perhaps by sector or some other criteria. The client then parses the result into a specialized internal data model from which individual requests can be serviced more quickly.

In one example, three-dimensional graphical display space where financial information and data is represented by three-dimensional object(s) and attributes may be created on a client, and the financial information and data may to be represented by the three-dimensional object(s) and attributed may be identified. Such identification may occur in response to user input, automatic determination, via loading default values, or combinations thereof. Default values may include i) location of series “building” equals strike price and contract expire date, ii) color represents implied volatility, and so forth. Next, a market set may be identified that specifies the context of contracts or underlying securities to be requested, such as geography, exchange, asset class, sector, index, etc. Example geography may be sub-divided into North America, EMEA (Europe, Middle East, and Africa), and Asia. The market set may be requested from a remote data source. This market set may include data corresponding to metric fields, which can number in the hundreds. The remote source may be server associated with the same entity as the example client, an archive, a data source associated with a third party, or any other appropriate data source. In some instances, the market set may be retrieved from multiple data sources, some of which may be local and other remote. For example, a relatively local source may store a majority of the desired data, while the remote source can provide a delta between that stored locally and the current state of information. The received market-set may be parsed into an internal data model and matched to the requested data and information. This matching could include quality control, double-checking, culling null fields, automatically retrieving missing data, and other data massaging to help ensure a robust data set. A graphical object may be created for each security in the received market-set with attributes that may be mapped to a representational form. Such attributes may include color, shape, shading, height, footprint, location, and so on. The graphical objects may be arranged into a form that is interpretable by an end user as a landscape containing a collection of contract “buildings.”

In another example, financial information may be served to a three-dimensional graphical display system at a client. The financial information may be served in response to a request from the client. The location, organization, and integration of data and information necessary to respond to the client request may be determined, and a response to the client request for the set of information may be calculated. In this example, the location may be a physical or logical location, the organization could be a data schema, and the integration could involve aggregation of live and static information or other data sets. The response may be developed according the client request in a format suitable for transmission over the respective network to the client's three-dimensional graphical display system. For example, this development may include compression, encryption, data supplementation, protocol translation, or any other suitable data messaging.

In another example, multiple one-, two-, and three-dimensional graphical display spaces can be integrated, and financial information and data can be represented by three-dimensional objects. A three-dimensional object is selected in one display space. The information represented by the three-dimensional object is used to uniquely identify the underlying security in the system data model, and the system data model is notified of the selection. In other words, the selection of different or changed data in one display can be published to other instantiated display objects. The system data model may publish the selection event to a set of listeners (one, two, or three-dimensional displays). The objects listening to system data model events may respond to the broadcast selection. Example 1D displays can include a head's up display, volume data, price, newswire, and so forth. Example 2D displays can include price charts, volatility charts, earnings charts, and other bars, graphs, and others. In this example technique, the 1D, 2D, and/or 3D displays or windows (or frames) can be linked such that modifying one display effects one or more of the others. For instance, changing the respective data set in the 2D display can change the data displayed in the 1D display. In another example, two 3D displays can be linked such that rotating one display rotates the other at the same speed, viewing angle, and so forth.

In another example, financial information and data can be combined to create new information that may then be represented by one or more three-dimensional object attributes. This technique may involve selection of one or more securities information and data series for calculation. A market-set is selected for calculation. The data and information are retrieved from the remote server and used to populate a system data model. The calculated criteria are specified for one or more of the data series. A calculation engine performs the calculations specified on the market set. The results are mapped to attributes of graphical objects representing entries of the market set.

In another example, a three-dimensional graphical display space is updated. The three-dimensional display space represents financial information and data by three-dimensional objects and attributes. This technique may involve requesting the market-set and/or data values stored in the system data model from a remote data source by, for instance, (a) a user-directed refresh or programmed automatic update at a particular time-interval or (b) a messaging (push) notification from the remote data source of a change. The market set is received from a remote data source and parsed into an internal data model. The requested data is matched to the data and information stored in the system data model. The arrangement of graphical objects is updated into a form that is interpretable by an end user as a derivatives contract landscape. Instead of using numbers to create charts and graphs alone, it converts numbers into three-dimensional patterns that are loaded into geometry and textures and applied to three-dimensional objects to create a landscape.

A financial platform is implemented by the example computing environment 100 shown in FIG. 1. The computing environment 100 includes one or more servers 120 or 122, one or more clients 104, and a network 114. FIG. 1 shows three example clients 104a, 104b, and 104c. The servers may represent one or more logical or physical locations for a financial application provider, such as backend process 116 and a frontend process 118. For example, as illustrated, the financial platform may be implemented using application servers 120 and database servers 122; but for ease of reference, such functionality as appropriate may be embodied within a single server or server bank and will be referred to as server 120. The server 120 includes memory and one or more processors and comprises an electronic computing device operable to receive, transmit, process, store or manage data associated with the system. Generally, this disclosure provides merely one example of computers that may be used with the described techniques. As used in this document, the term “computer” is intended to encompass any suitable processing device. For example, the platform can be implemented using computers other than servers, as well as a server pool. Indeed, the server 120 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. The server may be adapted to execute any operating platform including Linux, UNIX, Windows Server, or any other suitable operating system. According to one embodiment, the server may also include or be communicably coupled with a web server 130 and/or a mail server.

Memory 124 may include any storage or database module and may take the form of volatile or non-volatile tangible memory including, without limitation, magnetic media, optical media, random access memory (RAM), read-only memory (ROM), removable media, or any other suitable local or remote memory component. For example, this memory can include local RAM or any appropriate repository such as, for example, a secure server, a data center or warehouse, a dedicated computer, third-party data providers, and others. The memory may store some or all of classes, frameworks, applications, backup data, jobs, or other information that includes parameters, variables, algorithms, instructions, rules, or references thereto. The memory may also include any other appropriate data such as VPN applications, firmware logs and policies, firewall policies, a security or access log, print or other reporting files, HTML files or templates, and others.

The server 120 also includes a processor. The processor executes instructions and manipulates data to perform the operations of the server such as, for example, a central processing unit (CPU), a blade, an application specific integrated circuit (ASIC), or a field-programmable gate array (FPGA). Although described as a single processor in the server, multiple processors may be used according to particular needs and reference to processor is meant to include multiple processors where applicable.

The server 120 also includes an interface for communicating with other computer systems, such as the clients, over the network in a client-server or other distributed environment. Generally, the interface comprises logic encoded in software and/or hardware in a suitable combination and operable to communicate with the network. More specifically, the interface may comprise software supporting one or more communications protocols associated with communications such that the network or hardware is operable to communicate physical signals.

The network 114 facilitates wireless or wireline communication between the server and any other local or remote computer, such as the clients. The network 114 may be all or a portion of an enterprise or secured network. In another example, the network 114 may be an open or a virtual private network (VPN) between the server and the client across wireline or wireless link. Such an example wireless link may be via 802.11a, 802.11b, 802.11g, 802.11n, 802.20, WiMax, and many others. In yet another example, the network 114 may be a radio frequency (RF), CDMA, Long term evolution (LTE), or other cellular network. While described as a single or continuous network, the network 114 may be logically divided into various sub-nets or virtual networks without departing from the scope of this disclosure, so long as at least portion of the network may facilitate communications between the server and at least one client. The network 114 encompasses any internal or external network, networks, sub-network, or combination thereof operable to facilitate communications between various computing components in the system. The network may communicate, for example, Internet Protocol (IP) packets, Frame Relay frames, Asynchronous Transfer Mode (ATM) cells, voice, video, data, and other suitable information between network addresses. The network 114 may include one or more local area networks (LANs), radio access networks (RANs), metropolitan area networks (MANs), wide area networks (WANs), all or a portion of the global computer network known as the Internet, and/or any other communication platform or systems at one or more locations such as the example in FIG. 1A. In certain embodiments the network 114 may be a secure network associated with the enterprise and certain local or remote clients 104.

The client 104 is any computing device operable to present the user with the three-dimensional landscape in an appropriate form. To do so, the client 104 may connect or communicate with the server 120 or other components on the network 114 to collect financial data, metrics, updates, news, or other information that can enhance the user's experience or analysis. At a high level, each client 104 includes at least the GUI 105 and, in some cases, an agent and comprises an electronic computing device operable to receive, transmit, process and store any appropriate data associated with the backup system. It will be understood that there may be any number of clients 104 communicably coupled to the server 120 (or 122 and 130). For example, the clients 104 can include one local client and three external clients to the illustrated portion of the network. Further, “the client,” “customer,” “analyst,” “trader,” “investor,” and “user” may be used interchangeably as appropriate without departing from the scope of this disclosure. For example, the investor may also be a user of the client. Moreover, for ease of illustration, each client 104 is described in terms of being used by one user. But this disclosure contemplates that many users may use one computer or that one user may use multiple computers. As used in this disclosure, the client 104 is intended to encompass a personal computer or laptop, touch screen terminal or television, workstation, network computer, kiosk, wireless data port, smart phone, personal data assistant (PDA), one or more processors within these or other devices, or any other suitable processing device. For example, the client 104 may be a smartphone that includes an input device, such as a keypad, touch screen, trackpad, or other device that can accept information, and an output device that conveys information associated with the operation of the server or the clients, including digital data, visual information, or the GUI 105. Both the input device and output device may include fixed or removable storage media such as a magnetic computer disk, CD-ROM, or other suitable media to both receive input from and provide output to users of the clients through the display, namely the GUI 105. The client may also include, reference, or execute an agent to assist in data collection and presentation. The agent may be any script, library, object, executable, service, daemon, or other process.

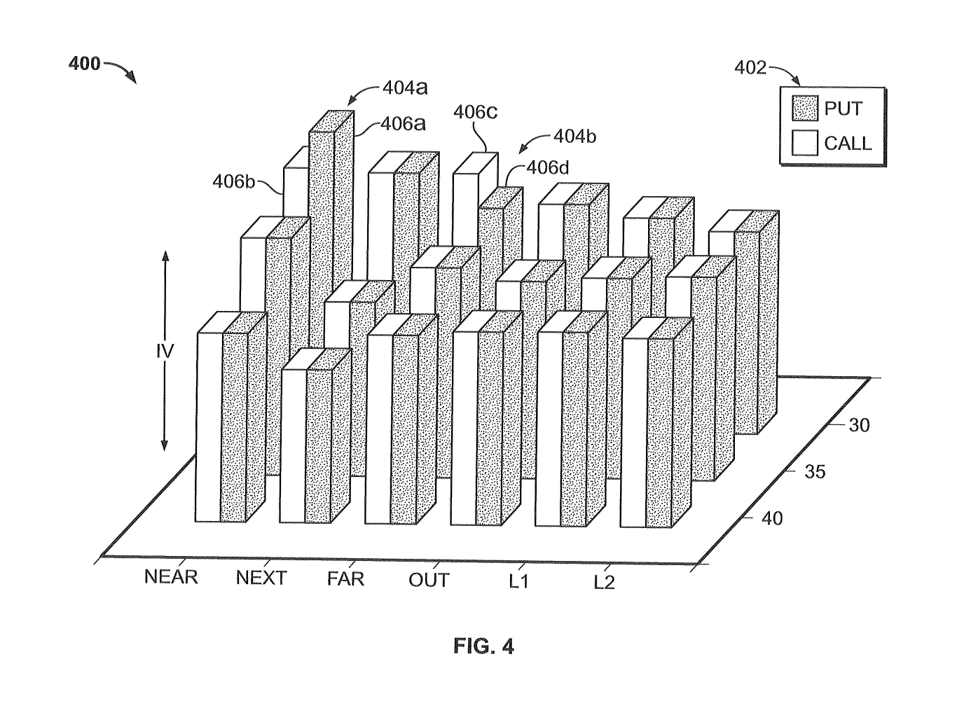

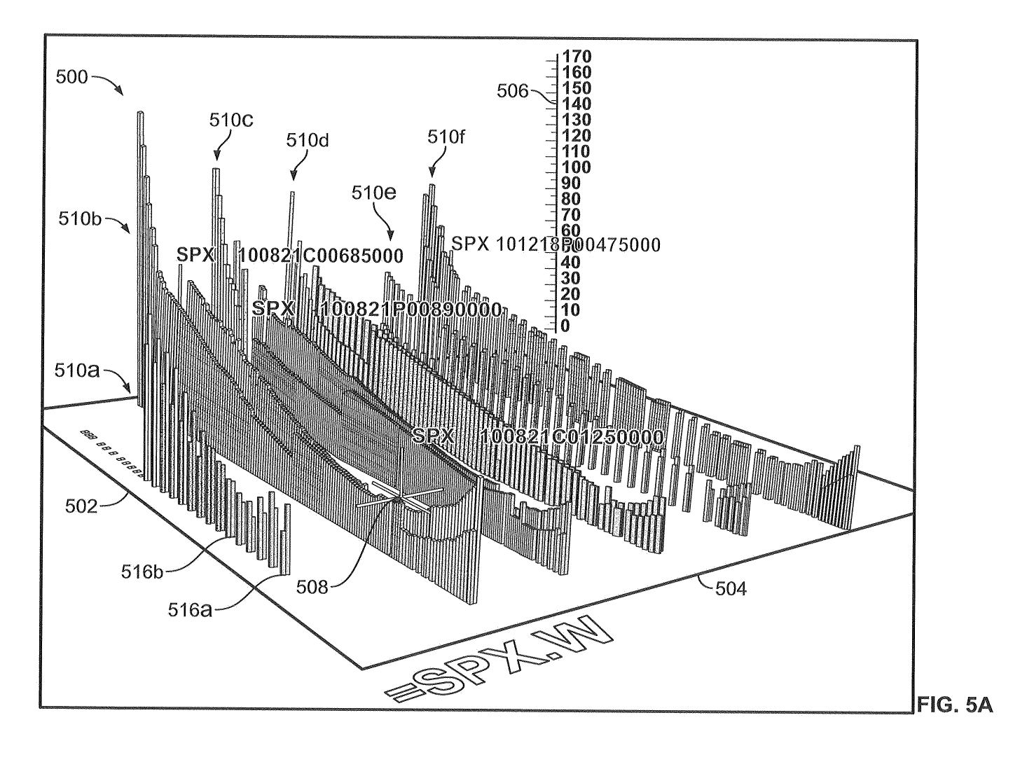

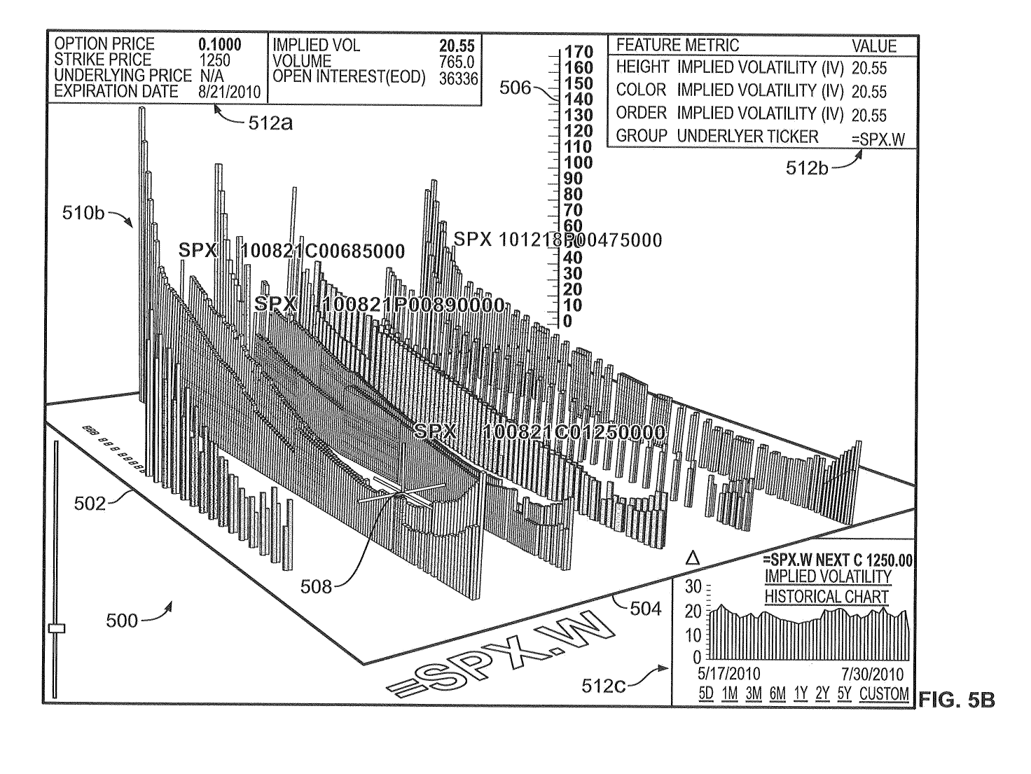

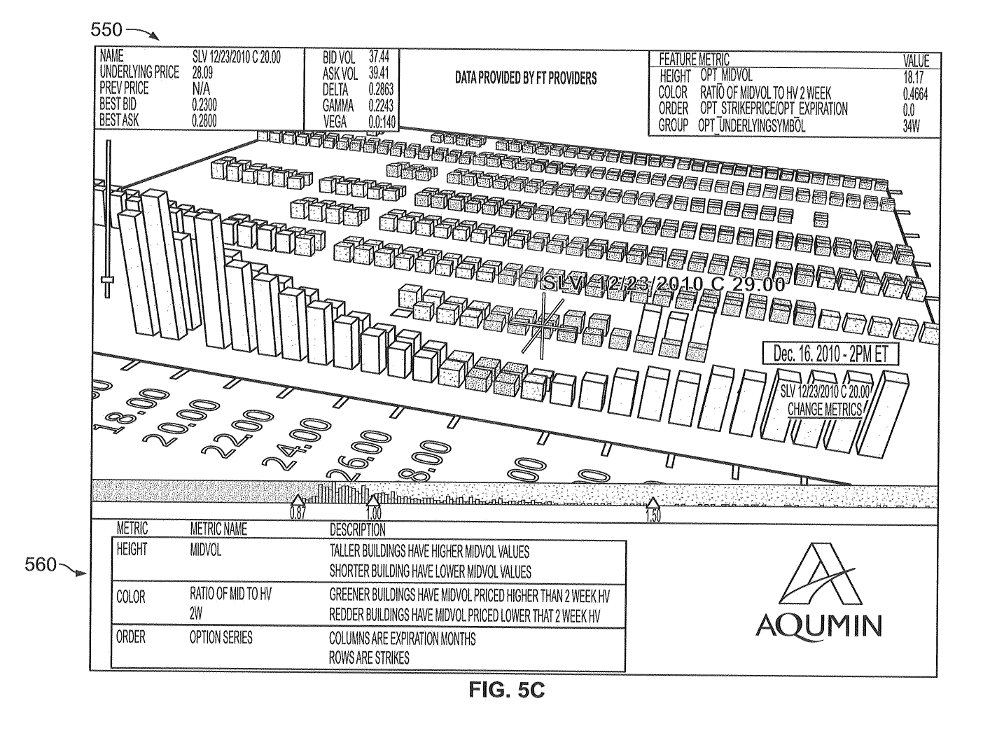

The GUI 105 comprises a graphical user interface operable to, for example, allow the user of the client to interface with at least a portion of the platform for any suitable purpose, such as viewing large financial data sets in a three-dimensional landscape. Generally, the GUI 105 provides the particular user with an efficient and user-friendly presentation of financial data provided by or communicated within the system. Example data displays are shown in FIGS. 4, 5A, 5B, and 5C. The GUI 105 may comprise a plurality of customizable frames or views having interactive fields, pull-down lists, and buttons operated by the user. The GUI 105 is often configurable, supports a combination of tables and graphs (bar, line, pie, status dials, etc.), and is able to build real-time portals, where tabs are delineated by key characteristics (e.g., site or micro-site). The GUI 105 is further operable to generate or request historical reports. Generally, historical reports provide critical information on what has happened including static or canned reports that require no input from the user and dynamic reports that quickly gather run-time information to generate the report. Therefore, the GUI contemplates any suitable graphical user interface, whether thick or thin, such as a combination of a generic web browser, intelligent engine, and command line interface (CLI) that processes information in the platform and efficiently presents the results to the user visually. The server can accept data from the client via the web browser (e.g., Microsoft Internet Explorer or Mozilla Firefox) and return the appropriate HTML, PHP, or XML responses to the underlying engine using the network.

This GUI 105 is generally considered a three-dimensional graphical display space where financial information and data is represented by a plurality of three-dimensional objects and attributes. This display space can illustrate data and its changes in real-time utilizing different graphical elements. For example, the display may present various sets of future financial payoffs (e.g., payoffs based on derivatives, bonds, etc.) as buildings in a three-dimensional landscape. Each building may comprise 96 vertices and 188 triangles, which may include 182 tristrips and 6 triangles. A color structured in color array can be stored with each vertex. Each entry in the color array can represent the RGBA (Red Green Blue Alpha) color space using float values, where alpha commonly represents opacity or transparency. To help optimize or enhance data flow and graphical processing, the particular metric may be stored in the alpha channel, which could greatly reduce the amount of data being processed perhaps using post interpolation lookup. For example, the alpha variable could be populated using the ENT/EBITDA. Moreover, the presentation of this financial data may optimize the use of the graphics card's vertex cache. For example, the matrix composites may be flattened into the nodes. In another example, a lookup table can be populated (perhaps keyed on OpenGLRenderString) with optimization settings for particular graphics card. As such, the flow of the information presentation can be three-dimensional, as well as highly interactive at HDTV rates, while displaying large amounts of information and metrics in a more readable, intuitive form.

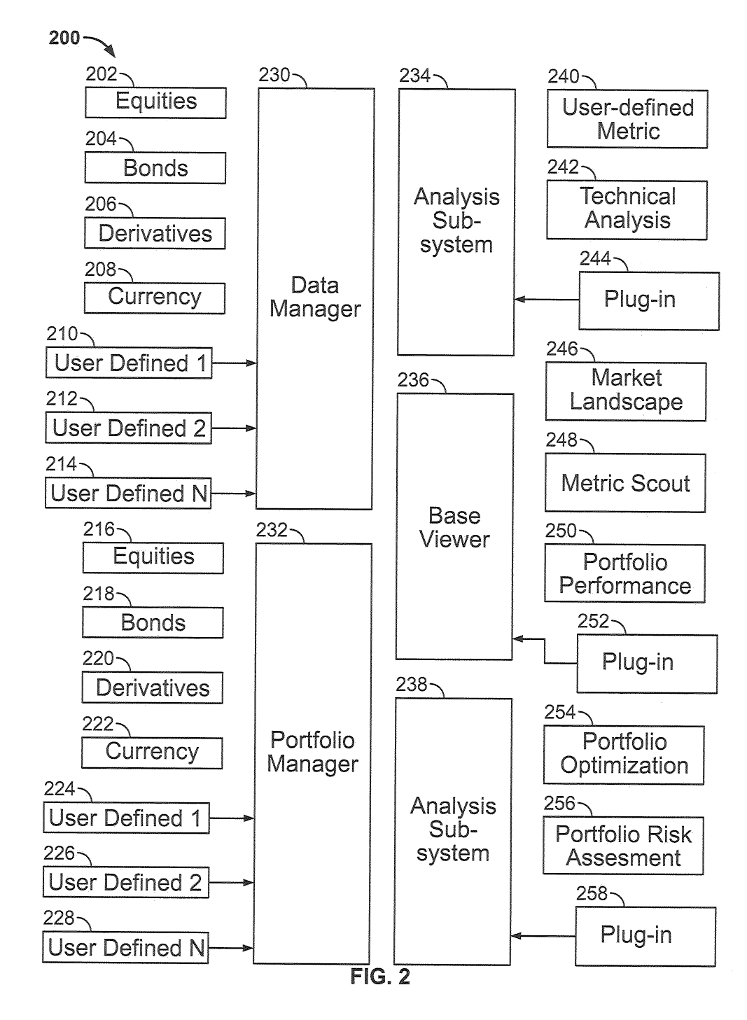

In certain embodiments, the client 104 executes a financial analysis engine 200, which is any software operable to invoke or execute certain described processes and that presents the information in a 3D-capable interface. Regardless of the particular implementation, “software” or “computer readable instructions” may include any software, firmware, wired or programmed hardware, or any combination thereof (embodied on or in tangible computer readable media) as appropriate to instruct the respective one or more processors. Indeed, the financial analysis engine 200 may be written or described in any appropriate computer language including C, C++, Java, Visual Basic, assembler, Perl, any suitable version of graphics software or APIs, as well as others. It will be understood that the engine 200 may include any number of sub-modules, such as a business application and third-party modules, but it may instead be a single multi-tasked module or web applet that implements the various features and functionality through various objects, methods, or other processes. For example, the engine 200 may include a metric computer or calculator module. This metric calculator module resides in the client and allows the user to manipulate the data received from the remote source directly within the programming environment. More specifically, it can provide the ability to create customized, or user-defined, metrics, which provides substantially more than mere filters or spreadsheets. This ability utilizes remote data that is automatically displayed in a visually intuitive fashion. In certain configurations, the engine 200 may implement functions or web services including i) GetContracts( ) that returns values such as contract name, ticker symbol, industry group code (sector) (the return values may also include additional (not required) fields such as actual hexadecimal identifier (Representation Number) TaxID (SIP), and exchange code); ii) GetAllltems( ) that returns item name and item code (all fields); and iii) GetMetricValues( ) that gets values from database according to field name (also returns and id code to tie to underlier). Further, while described as internal to the client or the server, respectively, one or more processes associated with the financial analysis engine 200 may be stored, referenced, or executed remotely. For example, a portion of the financial analysis engine 200 may be a local library or process, while another portion of the financial analysis engine 200 may be an object bundled for processing at a remote client. In another example, the majority of processes or modules may reside—or processing takes place—on the client. Moreover, the engine may be a child or sub-module of another software module or enterprise application (not illustrated) without departing from the scope of this disclosure. Such configurations may use modules such as those illustrated in FIG. 2 or other modules with similar functionality as appropriate.

FIG. 2 illustrates an example configuration or schematic of the financial analysis engine 200. As noted above, such a configuration is an example for illustrative purposes. The illustrated financial analysis engine 200 includes a number of modules such as a data manager 230, a portfolio manager 232, an analysis subsystem 234, a base viewer 236, and an analysis subsystem 238. The data manager 230 interfaces with an equities module 202, a bonds module 204, a derivatives module 206, and a currency module 208. The data manager 230 can also interface with a number of user defined modules such as a user-defined module 1 210, a user-defined module 2 212, and/or a user defined module N 214. Likewise, the portfolio manager 232 interfaces with a number of component modules. These component modules can include an equities module 216, a bonds module 218, a derivatives module 220, and a currency module 222. The portfolio manager 232 can also interface with a number of user defined modules 224, 226, and 228. The illustrated analysis subsystem 234 interfaces with a user-defined metric module 240, a technical analysis module 242, and a plug-in module 244. The example base viewer 236 interfaces with a market landscape module 246, a metric scout module 248, and a portfolio performance module 250. The base viewer 236 can interface with a plug-in module 252. The representative analysis subsystem 238 interfaces with a portfolio optimization module 254, a portfolio risk assessment module 256, and a plug-in module 258.

Using some or all of the foregoing example components and configurations, the server 120 (or server bank) can retrieve data from multiple data sources based on a (software or user-directed) request from a client 104. In this instance, each of the one or more data sources may be stored in an enterprise-wide repository as one or more tables in a relational database described in terms of SQL statements or scripts. In another embodiment, the stored data—whether financial, user, parameters, and so on—may be formatted, stored, or defined as various data structures in text files, eXtensible Markup Language (XML) documents, Virtual Storage Access Method (VSAM) files, flat files, BTree files, comma-separated-value (CSV) files, internal variables, or one or more libraries. In short, this financial data may comprise one table or file or a plurality of tables or files stored on one computer or across a plurality of computers in any appropriate format. Often, the data can be fetched and cached in real time (historical fundamental data: company history, annuals, dollar value of annual loans, and so forth) and then stored in the respective database. For example, the server-oriented database may be refreshed or otherwise intelligently updated from other remote data sources, such as six times a day via XML over File Transfer Protocol (FTP). These other remote data sources may comprise third parties that expose API sets or web services, perhaps via subscription, that provide the data to the server. This data can be fundamental information that doesn't change over the course of one day. For changing data (such as earnings release), it may be imported directly into the server's memory or (at least a subset) communicated directly to the client 104. In certain situations, the server 120 may fold data streams into memory and key to towards an ISIN field. In this way, each client 104 is able to easily access the data. Such access can be further enhanced through use of (encrypted) GZIP textual or octet-stream data communications through GZIP plug-ins, which are often already present at clients 104 and also allow clients 104 to add their own data streams. Once sent to the client, it is expected that certain clients 104 will cache the information (via HTTP or offline repository) such that request information may be locally obtained, perhaps using a hashed table, thereby reducing process time. In this example, each data item communicated from the server 102 may include a cache header with a timestamp and cache validity flag or length. When warranted, server 102 may force a cache deletion or purge from the client 104.

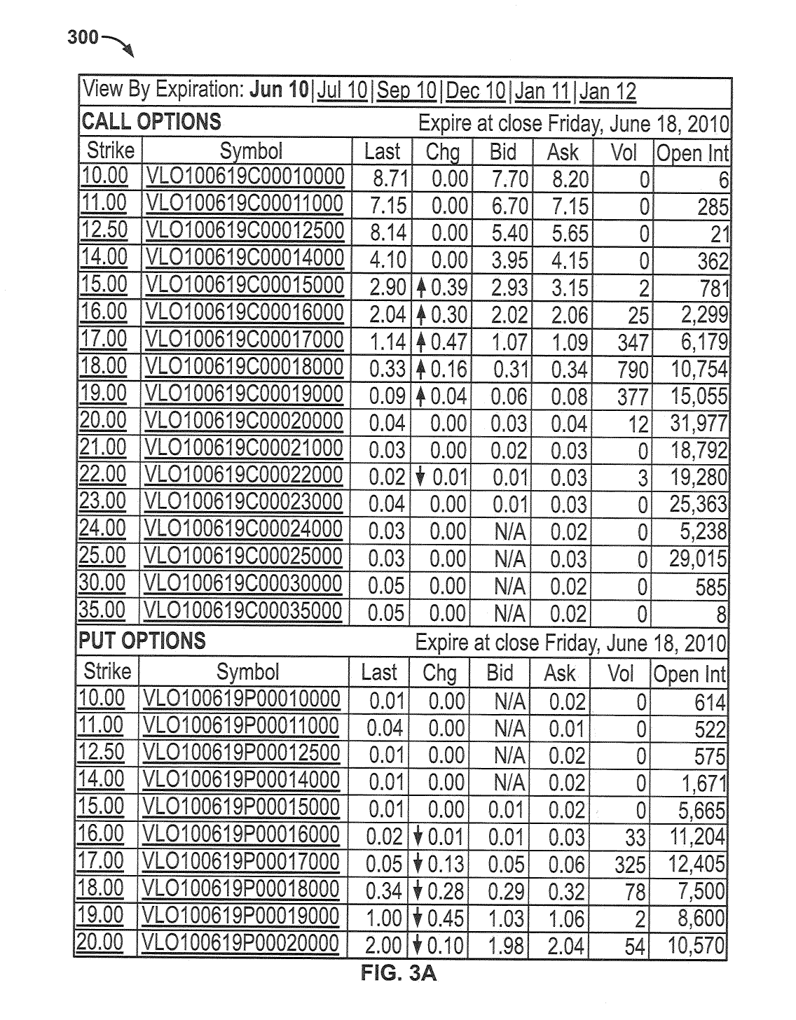

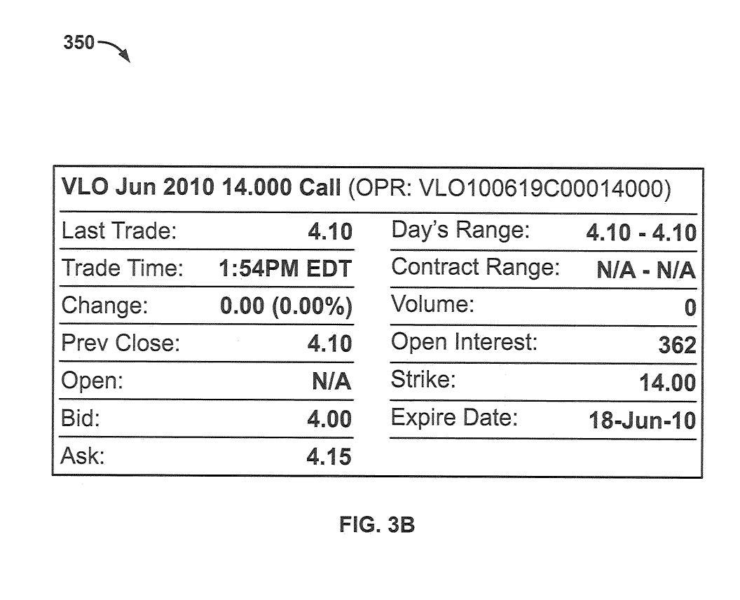

The three-dimensional landscape presented in the GUI 105 can represent data relating to bonds, equities, currencies, derivatives, futures, options, swaps, and/or other types of instruments. One example use of a three-dimensional landscape of data relating to derivatives contracts is the application to options trading. Conventional presentations of option data (e.g., the textual presentations shown in the example web pages of FIGS. 3A and 3B) provide a finite amount of information for a particular class of options and for a single series. In some cases, searching options pages/screens from conventional sources may require the trader to look at tens or hundreds of such screens in order to find the best price-to-value ratio for a proposed strategy. For example, table 300 shown in FIG. 3A provides call option data and put option data in a textual format arranged in lines and columns. Similarly, table 350 in FIG. 3B provides a quote summary in a textual format arranged in lines and columns. Such conventional presentations of financial information are often displayed as part of a web page, for example, by a web browser application.

FIG. 4 shows a conceptual sketch 400 of financial data presented in a three-dimensional landscape. The three-dimensional landscape includes a perspective view of a three-axis system. A first axis (horizontal) shows terms arranged from left to right in order of increasing time. A second axis (angled) shows the strikes arranged from front to back in descending order. A third (e.g., vertical) axis shows implied volatility of the call and put. Each of the discrete graphical elements (the “buildings”) in the three-axis system represents a call or a put. As indicated by the legend 402, the shaded buildings represent puts, and the unshaded buildings represent calls. The discrete graphical elements in the three-axis system are grouped according to term and strike price. The term of a future financial payoff indicates the time or time period at which the payoff matures, and the strike price indicates the value of the payoff when it reaches maturity (i.e., at the term). In the example sketch 400, each group includes two buildings for a given term and a given strike price. Two example groups 404a and 404b are labeled in the sketch 400. One of the two buildings in each group represents a call for the given term and strike price; the other building in each group represents a put for the given term and strike price. In the example shown, the buildings in each group are presented side-by-side for convenient and intuitive comparison of the implied volatility of the call and put represented by the group. For example, the buildings 406a and 406b in the group 404a are presented side-by-side so that a user can readily see the implied volatility for the put contract represented by building 406a is higher than the implied volatility for the call contract represented by building 406b. As another example, the buildings 406c and 406d in the group 404b are presented side-by-side so that a user can readily see the implied volatility for the put contract represented by building 406d is lower than the implied volatility for the call contract represented by building 406c. The call and put for a given term and strike price may be presented in different colors or in the same color.

FIGS. 5A, 5B, and 5C show three-dimensional landscapes of observed market values. FIG. 5A shows a first view of an example three-dimensional landscape 500, and FIG. 5B shows a second view of the example three-dimensional landscape 500 of FIG. 5A. The observed market values presented in example three-dimensional landscape 500 are based on the S&P 500 Options on May 17, 2010. In some implementations, observed market values based on additional or different types of future financial payoffs (e.g., bonds, etc.) are used. In FIGS. 5A and 5B, each of the S&P 500 Options is represented by a building in the three-dimensional landscape. A building is one example of a discrete graphical element; a three-dimensional landscape may be composed of other types of discrete graphical elements. The three-dimensional landscape 500 presents the buildings in a Cartesian coordinate system having three coordinate axes. The three-dimensional landscape 500 includes a first axis 502 that represents a range of strike prices, a second axis 504 that represents a range of expiration terms, and a third (e.g., vertical) axis 506 that represents a range of implied volatility values.

Visual attributes of the buildings in the three-dimensional landscape 500 represents observed market values for the S&P 500 Options. In particular, two visual attributes (the height and shading) of each building in the example three-dimensional landscape 500 indicate the implied volatility of a particular S&P 500 Options contract. In the example shown in FIGS. 5A and 5B, higher values of implied volatility are represented by lighter shading and taller buildings, while lower values of implied volatility are represented by darker shading and shorter buildings. In some instances, additional, fewer, or different types of visual attributes (e.g., color, texture, footprint, etc.) are used to represent the observed market values. As one example, where the color of each building represents the implied volatility, higher values of implied volatility can be represented by redder hues, while lower values of implied volatility can be represented by greener hues. At a high level, the example three-dimensional landscape 500 shown in FIGS. 5A and 5B indicates a volatility curve narrowing to its minimum point near the at-the-money strike.

The buildings are arranged in groups in the example three-dimensional landscape 500. In particular, each group in the three-dimensional landscape 500 includes two buildings that represent a set of options contracts—a put and a call for a given strike price and a given expiration term. Generally, a group of discrete graphical elements may include any number (e.g., 5, 10, etc.) of buildings or other types of discrete graphical elements. For example, in a three-dimensional landscape of observed market values for bonds, each group could include five or ten buildings that each represents a different bond interest rate or term. In the example shown in FIG. 5A, two example groups 516a, 516b are labeled for discussion purposes. The example group 516a includes two buildings that represent a first set of options contracts (a put and a call). The height of one of the buildings in the group 516a indicates the implied volatility of the put, and the height of the other building in the group 516a indicates the implied volatility of the call. Similarly, the example group 516b includes two buildings that represent a second set of options contracts (a different put and a different call). The buildings in the group 516a are presented side-by-side in the three-dimensional landscape to allow visual comparison of the implied volatilities for the put and call represented by the group 516a, and the buildings in the group 516b are presented side-by-side in the three-dimensional landscape to allow visual comparison of the implied volatilities for the put and call represented by the group 516b. The groups are arranged in rows and columns in the three-dimensional landscape. The groups in each column have the same expiration term, and the groups in each row have the same strike price. Six example columns 510a, 510b, 510c, 510d, 510e, 510f are labeled in FIG. 5A. The rows and columns in a three-dimensional landscape can be arranged to allow visual comparison of the observed market values of multiple different groups, for example, visual comparison of a series of groups having the same strike price, term, or other attribute. In FIGS. 5A and 5B, the columns are spaced apart in the three-dimensional landscape 500 to allow visual comparison of the implied volatilities across groups having the same expiration term.

As shown in FIG. 5B, a building in the three-dimensional landscape can be selected using a cursor 508. Additional information about an option (or another type of future financial payoff) represented by a building may be displayed upon a user's selection of the building. As shown in FIG. 5B, selecting the building that represents a particular options contract causes three additional data modules 512a, 512b and 512c to appear. FIG. 5C shows another example three-dimensional landscape 550. The view of the example three-dimensional landscape 550 shown in FIG. 5C shows that the landscape can be rotated, zoomed, and otherwise manipulated for visual analysis. FIG. 5C also shows a detail module 560 that indicates how the data is arranged in the three-dimensional landscape 550.

As shown in these examples, by populating a derivatives contract landscape with option data, a user may compare an entire option class or multiple option classes with all series, for multiple underlying securities at once. Such graphical representations of data may efficiently convey skew, time spreads, hard to borrow, volume, implied volatility, and/or other information. In some implementations, the data presented in the derivatives contract landscape can be updated in real time. This may allow the user to quickly ascertain the value of a particular trade or series in the context of the option class or multiple classes of options.

In some examples, a trader attempting to buy volatility in the energy sector may wish to maximize the amount of volatility purchased for a given dollar amount. In some instances, using a derivatives contract landscape populated with implied volatility and last price data for options contracts on firms in the energy sector, the trader is able to quickly see ranges of “green” where the optimal trade can be made. When this example landscape is populated with real-time data from a provider such as Hanweck & Associates via ActivFinancial's Volera data feed, this landscape can be made “live,” ticking second-by-second and providing an instantaneous view of where the optimal trade can be placed. A three-dimensional landscape of other types of observed market values may be used in a similar manner.

The color, footprint, and other visual aspects of a “building” may represent various properties of the contract. For example, the color of each “building” may represent changing implied volatility (e.g., change in volume, volatility, etc.), the footprint of each “building” may represent the volume, and/or other information may be presented in this manner. In some implementations, a user can use a pointer to indicate one of the buildings, for example, by hovering over or clicking the building. As a result of the user indicating a building, further data for the building (e.g., the current market prices for the option, the change in its price, volatility of the bid and offer, open interest, and/or others) may be displayed.

The three-dimensional landscape may include an historical feature that allows a user to look back and grab EOD data from the past and get snapshots of evolving conditions. Since values can be imported, a user can import theoretical values and test with the color bar what is overvalued or undervalued. A graphical representation may include a landscape of many classes (e.g., IBM, MSFT, AMD). In some cases, when the user zooms, a class can occupy the full screen.

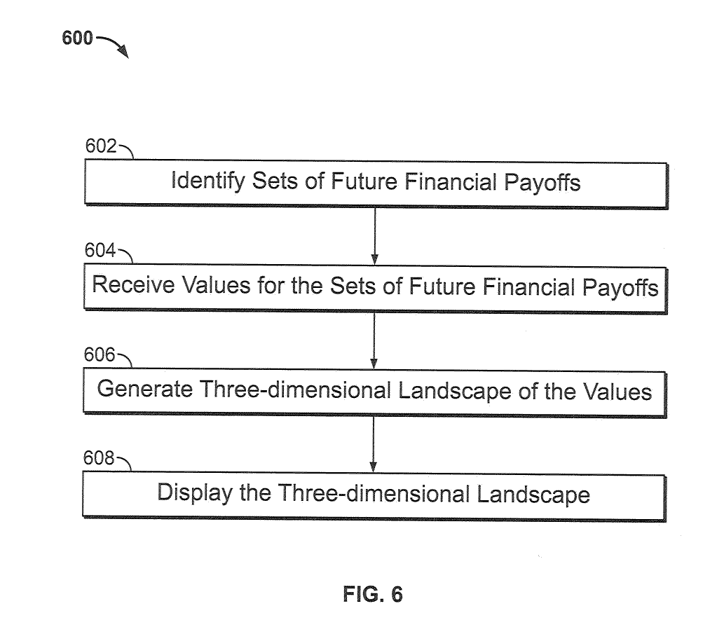

FIG. 6 is a flow chart showing an example process 600 for generating a three-dimensional landscape of financial information. The example process 600 can be implemented by a computer system, for example, by one or more components of the example computing environment 100 of FIG. 1. Some or all aspects of the process 600 may be executed at one or more client devices, at one or more server devices, or at a combination of server and client devices. The process 600 may include additional or fewer operations performed in the order shown or a different order. In some implementations, one or more of the operations in the process 600 is iterated or repeated, as appropriate. In some examples, the process 600 provides a graphical display of financial data such as, for example, a graphical display of any of the three-dimensional landscapes shown in FIGS. 5A-5C or another type of three-dimensional landscape.

At 602, multiple sets of future financial payoffs are identified. The future financial payoffs may include any type of future financial payoffs that can be organized in multiple different sets according to any type of criteria for analysis. Examples of future financial payoffs include bonds, derivatives contracts (e.g., futures contracts, options contracts, swap contracts, and/or other types of derivatives contracts), and others. For example, derivatives contracts for a given security can be organized into sets, where each set includes a put contract and a call contract having the same term and the same strike price. As such, each set of future financial payoffs may include opposing payoff positions (e.g., a call and a put), where unequal observed market values of the opposing payoff positions for a given term and a given strike price indicates a deviation from theory. In other words, although the observed market values for a set of future financial payoffs are often unequal, they should theoretically be equal at least in some instances. However, in some cases, differences among the values for a set of future financial payoffs do not indicate a deviation from theory. For example, bonds can be organized into sets, where each set includes bonds having the same term and different interest rates.

At 604, values for the sets of future financial payoffs are received. For example, the values may be received from memory, received from a remote data server, or from another source. The values may include observed market values for each set of future financial payoffs. The observed market values for the sets of future financial payoffs include, or are derived from, actual market data as opposed to theoretical projections. For example, the observed market values may include values included in or derived from a real-time or end-of-day market data feed. The observed market values may include real-time or end-of-day implied volatility (bid, ask, mid), options contract Greeks (delta, vega, gamma, theta, rho), implied interest rate yield information, trading volume, open interest, and so forth.

At 606, a three-dimensional landscape of the values is generated. The three-dimensional landscape is composed of discrete graphical elements. Generally, each of the discrete graphical elements has a visual attribute that represents the observed market value for one of the future financial payoffs. For example, the three-dimensional landscapes shown in FIGS. 5A-5C are composed on buildings, where the height of each building indicates an observed market value for a future financial payoff. Typically, the three-dimensional landscape includes a graphics data object or data set that may be stored in memory and rendered for display.

The three-dimensional landscape allows multiple derivatives to be analyzed in relation to one another. For example, the derivatives contract landscape may include a comprehensive view of an entire market (or selected or filtered subsets, such as by geography, equity type, and so forth) at one time. The derivatives contract landscape may include data relating to futures, options, swaps, and/or other types of derivatives. The user can manipulate this derivatives contract landscape in three dimensions by rotating, zooming, or flying over the plane of financial data, often without losing the context of the overall map or resolution of the particular metrics being displayed.

In some implementations, the three-dimensional landscape includes groups of discrete graphical elements representing the sets of future financial payoffs. A group of discrete graphical elements may be designated by their positions in the three-dimensional landscape, or a group may be designated by the color, texture, size or other visual attributes of the discrete graphical elements in the group. In some instances, a group may be explicitly labeled. The discrete graphical elements in each group can be positioned in proximity to each other in the three-dimensional landscape to allow visual comparison of the observed market values for the set of future financial payoffs represented by the group. For example, by visually comparing the heights of the buildings in a group within the three-dimensional landscape, a user can intuitively identify any difference between the observed market values for the financial payoffs represented by the group. The three-dimensional landscape can be generated in a highly memory-efficient manner and with high quality performance in real-world use cases. The groups can be organized and the grid for the three-dimensional landscape can be generated in a highly parallelized fashion, taking advantage of additional CPU cores present on many computing devices today.

In a derivatives contract landscape, the three-dimensions may correspond to the term, strike value, and observed market value. For example, in some instances, multiple strike values are represented along a longitudinal dimension, multiple terms are represented along a latitudinal dimension, and a range of observed market values are represented along a vertical dimension. In such cases, the location of each building in the longitudinal and latitudinal dimensions indicates a strike value and a term for the future financial payoff represented by the building, and the height of each building in the vertical dimension indicates the observed market value for the future financial payoff represented by the building. In some instances, the dimensions may be interchanged, inverted, or otherwise reconfigured. In addition to height, each of the buildings may have a second visual attribute (e.g., color, texture, shading, footprint) that indicates a second, different observed market value for the future financial payoff represented by the building.

At 608, the three-dimensional landscape is displayed. For example, the three-dimensional landscape may be displayed by a computer monitor, a display screen of a wireless device, a television screen. Because computer screens and other display devices typically present information in two dimensions, the three-dimensional landscape is displayed as a two-dimensional graphic in some implementations. When the three-dimensional landscape is displayed as a two-dimensional graphic, all three dimensions of the three-dimensional landscape are represented in the two-dimensional graphic. For example, various conventional projection techniques may be used to represent a three-dimensional object in two-dimensions. In some instances, the three-dimensional display is displayed in three-dimensions. In some cases, the three-dimensional landscape can be generated, displayed, and or updated in real-time. For example, the observed market values may be updated as market data becomes available, and the three-dimensional landscape may be modified accordingly.

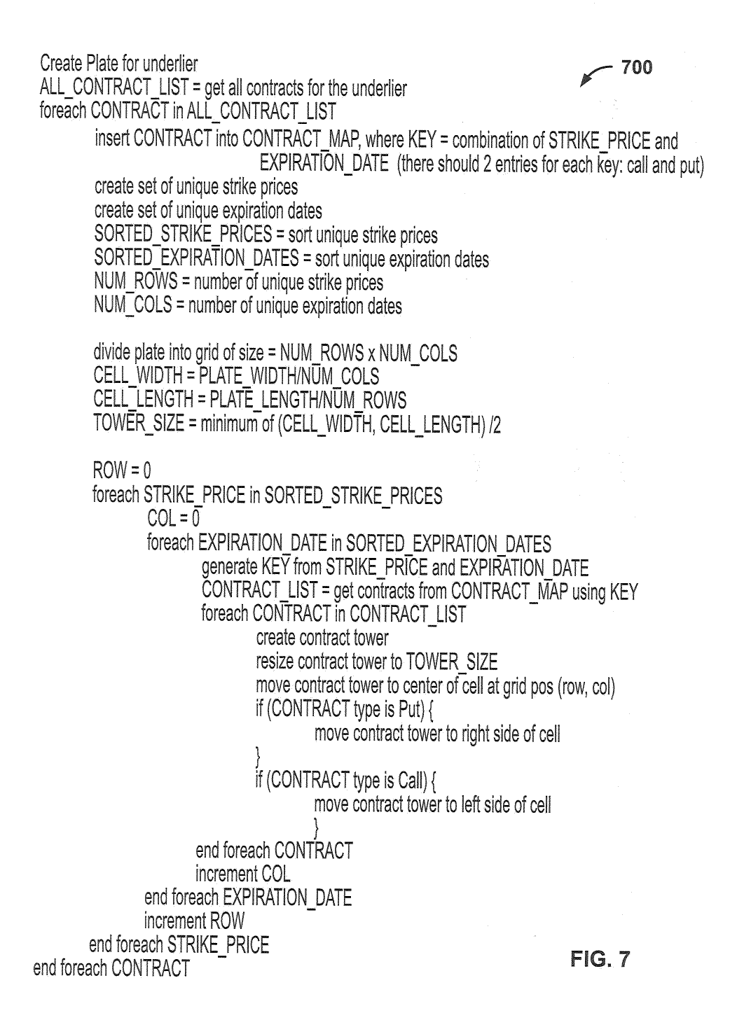

FIG. 7 is pseudo-code for an example algorithm for generating a three-dimensional landscape of financial information. For example, aspects of the example algorithm may be used to generate all or part of the three-dimensional landscapes shown in FIGS. 5A-5C. In some instances, the example algorithm can be used to implement aspects of the example process 600 shown in FIG. 6. The pseudo-code may be converted to any suitable programming code, including compiled codes and/or executable codes in any machine-readable format or programming language. The pseudo-code may be implemented as software, for example, a computer program product. The software can include instructions that are executed by a data processor to perform the algorithm.

In some implementations, the techniques described herein can be used for efficiently accessing, processing, displaying, or otherwise managing series-based financial securities information for large numbers of issues. For example, software can be implemented to efficiently map the daily percent-change in stock price, daily cumulative total return, or daily price-to-earnings ratio for the period from Jan. 1, 2000 to Jan. 1, 2010 of every firm in the S&P 1500, Dow Jones Industrial Average, and Nasdaq 100 into an interactive space, thereby enabling a user to interrogate, interpret, and analyze this information in a more productive setting. Example series-based financial data can include: time-series information such as the daily percentage change in price, the daily closing P/E Ratio, the quarterly return on equity; the annual return to shareholders; tick-series information such as bid, ask, and spread values on a financial exchange, daily cumulative total return net of dividends, quantitative metrics, cash flow analyses, earnings updates, news or news sentiment data, other EOD market data, SEC filings, or any other sequential financial data metric. The series-data-map can provide a comprehensive view of an entire market (or selected or filtered subsets, such as by geography, equity type, and so forth) at one time. In some instances, the user can manipulate this series-data-map in three dimensions by rotating, zooming, or flying over the plane of financial data, often without losing the context of the overall map or resolution of the particular metrics being displayed.

In some examples, the time-series data is displayed in a three-dimensional landscape that includes graphical elements arranged in a layout that is interpretable by an end user as a series-data-map containing a collection of issue “traces.” In some cases, the location of a series trace in the three-dimensional landscape indicates market capitalization and the color of a graphical element in each trace represents percent-change in price. For example, in the case of time-series data, a historical data map may be created to show the time-period surrounding a particular event (e.g., the 2001 recession) from the standpoint of both cumulative total return, and percent change in price.

Different types of visual layouts can be used to present series information across large numbers of underlying securities. For example, historical series data, geographical series data, and other types of series data can be displayed as a texture map, as a three-dimensional landscape, or in another type of layout. The texture map layout provides a convenient condensed overview of the data, which allows the user to discern high-level features and trends. The texture-map based approach can utilize very large texture objects (e.g., greater than 16 million texels or 4096×4096 equivalent scale). The three-dimensional landscape allows the user to drill-down and analyze individual data points in comparison to other individual data points in the landscape. For example, when each individual data point is represented directly by a geometric building in the three-dimensional landscape, a user can select a particular data point distinctly and precisely. In some implementations, zooming in or “drilling down” in the three-dimensional landscape can be done while keeping the particular data point in context with its neighbors. A landscape-based approach can be implemented in a highly memory-efficient manner and with high quality performance in real-world use cases. In particular, the grouping and grid-layout engine is highly parallelized and takes advantage of additional CPU cores present on many computing devices today. The landscape-based approach can use smaller textures and can be scaled down to older graphics cards gracefully.

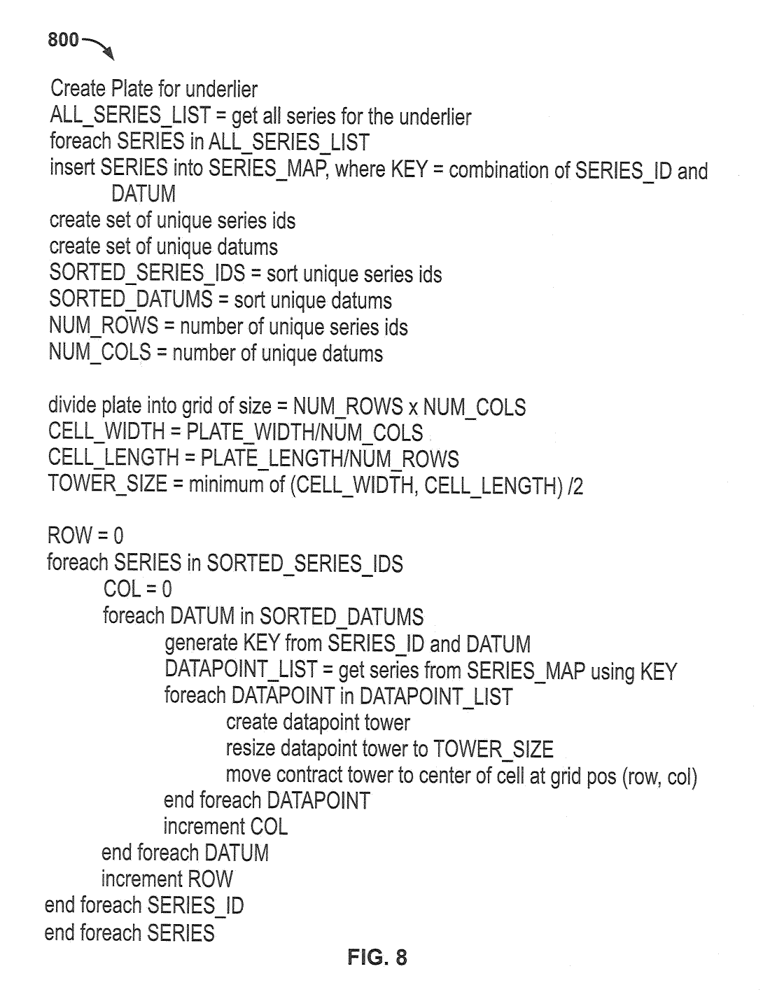

FIG. 8 is pseudo-code for an example algorithm for generating a three-dimensional landscape of financial information in a series format. For example, aspects of the example algorithm may be used to generate all or part of a three-dimensional landscape of series-based information for multiple underlying securities. The series can be a time-based-series, a geography-based-series, or another type of series. The pseudo-code may be converted to any suitable programming code, including compiled codes and/or executable codes in any machine-readable format or programming language. The pseudo-code may be implemented as software, for example, a computer program product. The software can include instructions that are executed by a data processor to perform the algorithm.

In some instances, a historical data landscape may be constructed by fetching the sequence of time-series data points for each issue, and placing the data points in temporary memory arrays either in RAM or on disk. Once the complete fetch for all issues is complete, traces for each issue are aggregated into a single floating-point (or double precision) texture-map by using memcopy to copy each trace to a location within a larger 2-dimensional array. To generate one or more aspects of the landscape, the floating point or double precision values at each texel within texture map may be used as an index into a colormap defining the colors and the specific value-ranges to which they apply. This colormap-lookup can take place within the pixel-shader engine of a graphics processing unit (GPU) in order to help ensure interactive performance (typically greater than 24 frames per second). The texture creation can be implemented in a high-level systems language (e.g., C++, Java, C#, etc.) while the colormap-lookup can be implemented in a suitable shader-engine language such as GLSL, Cg, or HLSL. Once the landscape has been created, a user may observe trends in the landscape. For example, a user may observe a concentration of negative total return in a particular time period within a particular sector (e.g., a concentration of negative total return within the Information Technology & Telecommunication Services Sector for the 2001 recession, etc.). Furthermore, the user may interact with the landscape, clicking on it to identify a trace for a specific issue and point in time.

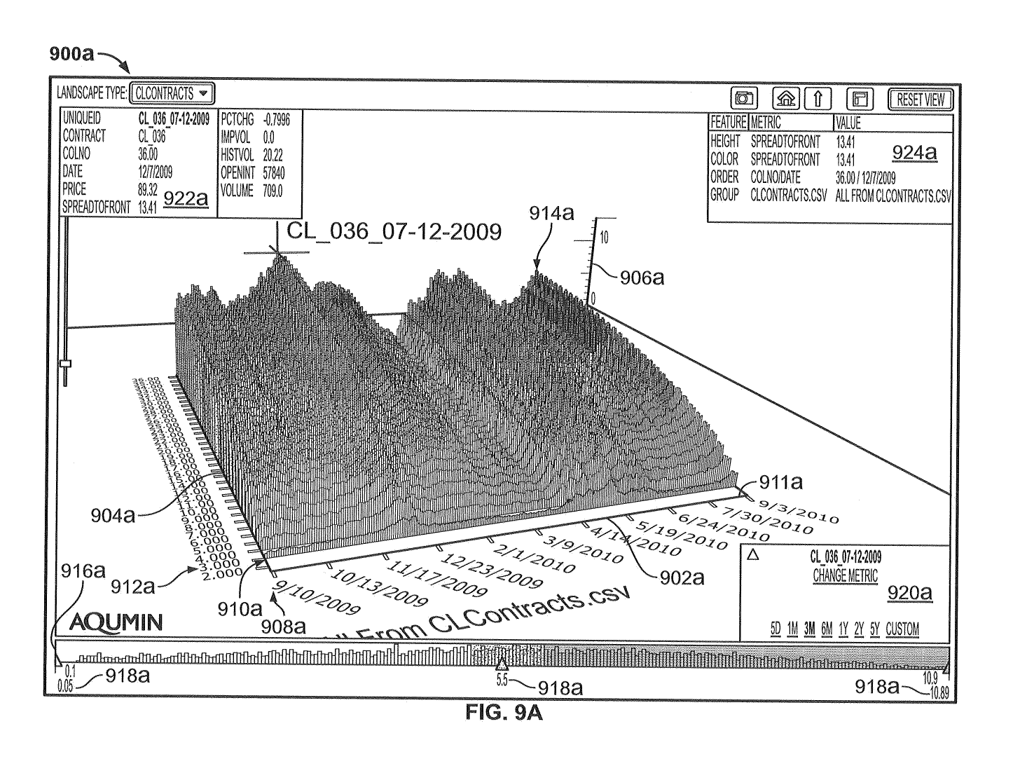

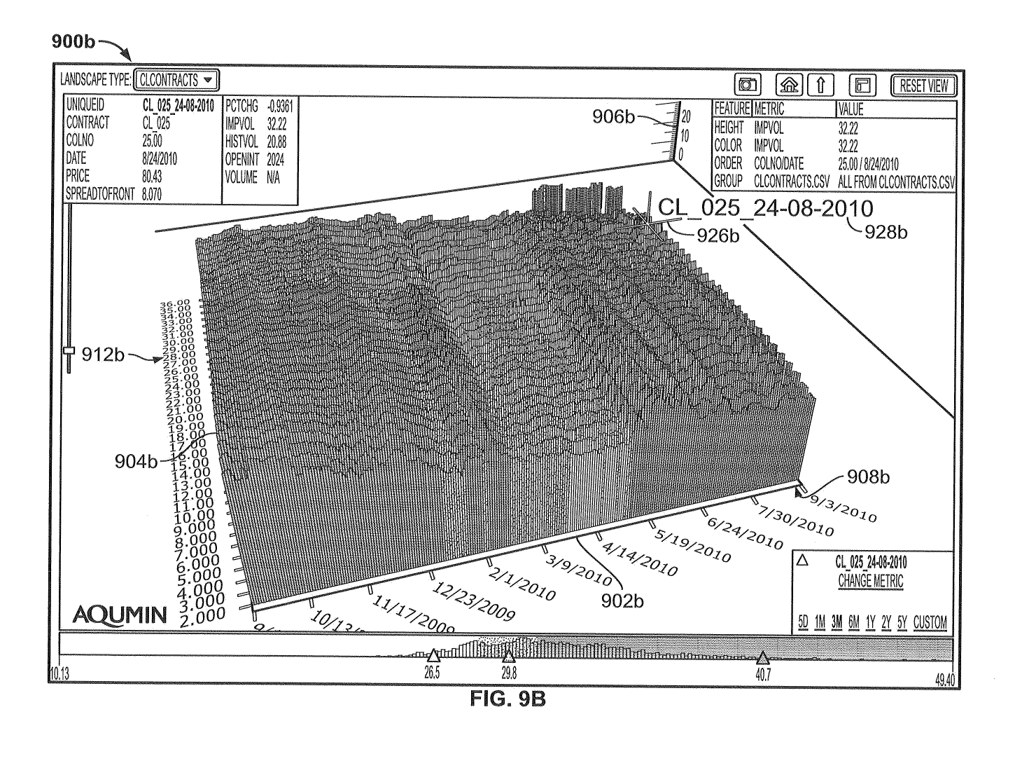

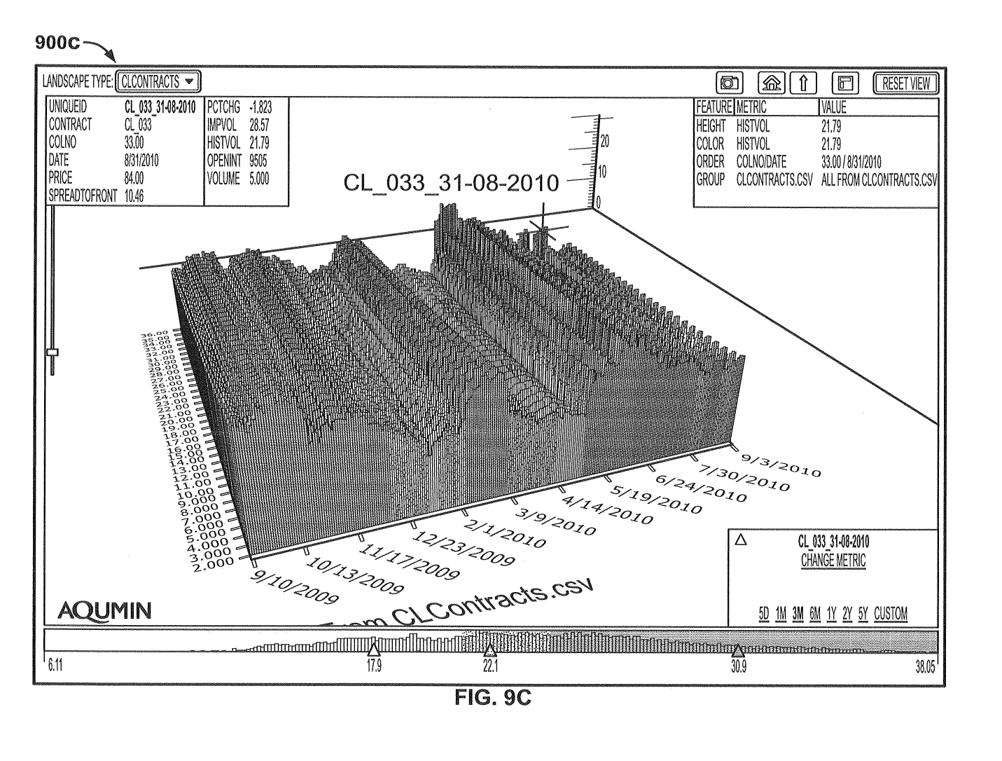

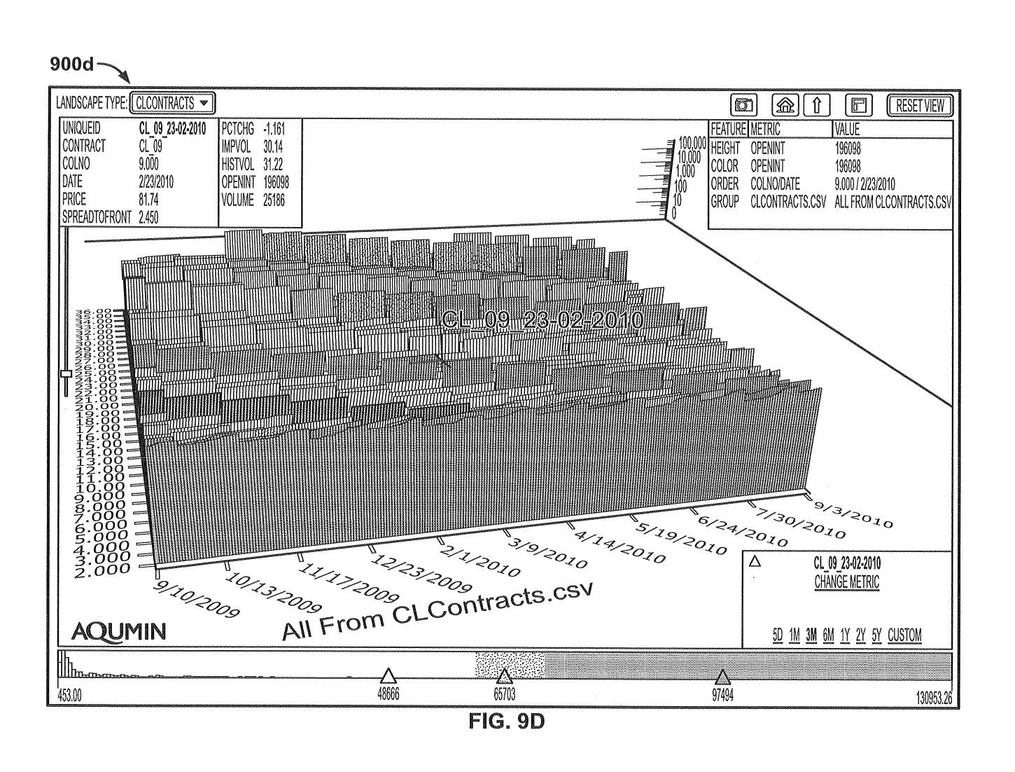

FIGS. 9A, 9B, 9C and 9D show three-dimensional landscapes 900a, 900b, 900c and 900d, respectively, that provide series-based financial information generated from observed market values (e.g., based on current and/or historical information). The three-dimensional landscapes 900a-900d can represent the observed market values as arrays of discrete graphical elements. The example three-dimensional landscapes 900a-900d are based on derivatives contracts. A series-based three-dimensional landscape may be based on other types of financial instruments, business intelligence metrics, and/or other objects of interest. In some implementations, the financial instruments can include financial contracts, equity securities, debt instruments or other financial or market-based information. Financial contracts can include, for example, futures contracts, options contracts, derivatives contracts, swap contracts, or other types of financial contracts. In some instances, derivatives contracts data can include real-time or end-of-day implied volatility (e.g., bid, ask, mid), options contract Greeks (e.g., delta, vega, gamma, theta, rho), implied interest rate yield information, and other data metrics.

In some examples, the observed market values that are used to produce the landscapes 900a-900d can be requested by the user as needed or updated automatically, such as by downloading the observed market values in real time. In some implementations, downloading the observed market values in real time can include sending compressed text over HTTP or HTTPS, as described earlier with reference to FIG. 1.

Example data points can be based on end-of-day closing prices, market-close closing prices, one or more intra-day prices, prices at market open times, or other prices or values. Groups of related data points (e.g., related as a series by time or other relationship) can be displayed as arrays of discrete graphical elements representing the plurality of series of data points, or the values thereof. When displayed in this way, for example, the arrays of discrete graphical elements can provide a three-dimensional topography that can make it significantly easier for a user to comprehend relationships among the values than might otherwise be possible. Discrete graphical elements representing data points can further include one or more visual attributes. Example visual attributes include the size (e.g., height, width, etc.) of the data point, its color, or some combination of those or other visual attributes.

Each of the three-dimensional landscapes 900a-900d can have various dimensions, such as a longitudinal dimension that can represent, for example, forward month values, a latitudinal dimension that can represent, for example, time points, and a vertical dimension that can represent a range of observed market values. Data points in the three-dimensional landscapes 900a-900d can be represented as buildings. For example, the location of each building in the longitudinal and latitudinal dimensions can indicate the forward month value and the time point to which the data point represented by the building is associated. The height of each building in the vertical dimension can indicate the observed market value for the data point represented by the building.

In some instances, the footprint of each building can indicate a second observed market value for the data point represented by the building, such as a value that is different from the observed market value for that data point. In some cases, the second observed market value can be a trading volume or a deviation from average trading volume. In some implementations, each of the buildings can have a color that indicates a third observed market value for the data point represented by the building. In some implementations, the observed market value can be a price value, an implied volatility value, a bid value, an ask value, a mid value, a delta value, a vega value, a gamma value, a theta value, a rho value, an implied interest rate yield value, or a ratio based on one or more of these values. In some implementations, each type of visual attribute can have a different meaning, such as the height of a data point indicating its value, and the color of the data point having a different meaning (e.g., a volatility), and so on.

When any of the three-dimensional landscapes 900a-900d is displayed, each of the dimensions can have different meanings. For example, a first (e.g., latitudinal) dimension can indicate time. In this way, the data points in an array of data points in the first (e.g., latitudinal) dimension each indicate a different forward month value, an hour, a day, a week or other time increment or timestamp. Each data point can be displayed adjacent to other data points, allowing a series of data points to be analyzed visually and providing a visual representation of any trends that are inherent from the data points. The series can be spaced apart from each other in the landscape to allow the trends within each series to be compared against the trends in other series. Moreover, the individual data points in a given series can be compared to corresponding data points in other series.

Referring to FIG. 9A, the values presented in the example three-dimensional landscape 900a, for example, are spread-to-front values that are based on the S&P 500 Options through Sep. 3, 2010. In some implementations, spread-to-front values based on additional or different types of commodities can be used. The example three-dimensional landscape 900a presents the buildings in a Cartesian coordinate system having three coordinate axes. The three-dimensional landscape 900a includes a first (e.g., latitudinal) axis 902a that represents a range of contract months, a second (e.g., longitudinal) axis 904a that represents a range of front months, and a third (e.g., vertical) axis 906a that represents a spread-to-front amount. The example landscape 900a depicts the price spread for 36 series of oil-futures contracts from the contract month to the front month. For example, at a Sep. 10, 2009 contract month 908a, the first building 910a in a first time-series 912a (e.g., for three-month options) represents the discrete data point that is the spread from Sep. 10, 2009 to Dec. 10, 2009. In this example, if the Sep. 10, 2009 contract is pricing at $90/bbl (i.e., ninety dollars per standard barrel of crude oil), and the Dec. 10, 2009 contract is pricing at $91/bbl, then the spread-to-front (i.e., first building 910a) is $1/bbl. In another example, if the January 2011 contract is pricing at $90/bbl, and the February, 2011 contract is pricing at $92/bbl, then the spread-to-front is $2/bbl. The last time series 911a in the three-dimensional landscape 900a can be, for example, Sep. 3, 2010 to Sep. 3, 2013 (i.e., 36 months out). In this example, if the Sep. 3, 2010 contract is pricing at $90/bbl and the Sep. 3, 2013 contract is pricing at $121/bbl, then the spread-to-front is $31/bbl.

In some cases, to generate three-dimensional landscapes such as the landscape 900a, contracts can be rolled forward every month and normalized, e.g., so that there are no gaps in the time-series. For example, the tenth month contract (i.e., 10.00 on the second axis 904a representing front months) is always ten months away from expiration, e.g., expiring in October for January contracts, expiring in November for February contracts, and so on.

In some instances, spread-to-front information provided in the landscape 900a can be very useful (e.g., to a user, such as an investor, broker, etc.) for observing market expectations of forward interest rates, and expected crude oil demand within a complete historical context. For example, the landscape 900a can provide a visual representation of information from which the user can also notice, using visual inspection of the displayed information, a very high degree of correlation.

In some implementations, buildings such as the building 910a can be presented in different forms to indicate relative values (e.g., spread-to-front amounts) that they represent. In some instances, additional, fewer, or different types of visual attributes (e.g., color, texture, footprint, etc.) can be used to represent the observed market values. As one example, where the color of each building represents the implied volatility, higher values of implied volatility can be represented by redder hues, while lower values of implied volatility can be represented by greener hues. Other implementations can use other color-coding schemes or other techniques (e.g., shading, textures, footprints, etc.). In some cases, controls or tools can accompany the landscape 900a (and/or other landscapes described in this specification) that the user can use to rotate, zoom, and/or otherwise manipulate the landscape for visual analysis.

In FIG. 9A, arrays of buildings span the time dimension, and the arrays are spaced apart from each other in the front month dimension. As such, in the example shown here, the spacing between buildings in the time dimension is minimal or even imperceptible to the user, and the spacing between arrays in the forward month dimension is pronounced and clearly visible to the user. The buildings are adjacent to each other in the array so that point-by-point changes and time-based trends in the data can be visually identified and analyzed. The arrays are spaced apart from each other so that each array appears as cohesive object that can be visually compared to other arrays. In particular, the point-by-point changes and trends within each array can be compared to the point-by-point changes and trends within other arrays.

In some instances, a color palate 916a can represent the universe of possible colors that can be used for buildings in the landscape 900a. For example, the color palate 916a can range from a darker shading to a lighter shading. In some implementations, context-value markers 918a can identify the minimum, mean and maximum colors that currently appear in the landscape 900a. For example, depending on the data displayed in the landscape 900a, not all of shadings may be represented in the landscape. In some cases, other colors and statistical values can be marked.

In some examples, hovering over, clicking on or otherwise selecting in some way any specific building can cause drill-down information to be provided. For example, the values of the axes can be identified. In some implementations, hovering over, clicking on or otherwise selecting in some way any specific point on either of the axes 902a or 904a can result in highlighting or displaying only that corresponding series of buildings. For example, clicking on the Sep. 10, 2009 contract month 908a can cause the 36 months of values corresponding to that date to be highlighted and/or displayed, e.g., optionally temporarily hiding the other series in the landscape 900a. In some instances, mouse-dragging or some other selection technique over a length of either of the axes 902a or 904a can cause the multiple corresponding series of buildings to be displayed. In some cases, data areas, such as data areas 920a, 922a and 924a can provide summaries or detailed information (e.g., drill-down information) of individual data points in the landscape, arrays of data points, or the entire landscape.

Referring to FIG. 9B, the values presented in the example three-dimensional landscape 900b, for example, are implied volatility values based on the S&P 500 Options through Sep. 3, 2010. In some implementations, implied volatility values that are based on additional or different types of commodities can be used. The three-dimensional landscape 900b includes a first axis 902b that represents a range of contract months, a second axis 904b that represents a range of future months, and a third (vertical) axis 906b that represents an implied volatility amount.

In some implementations, controls such as a cross-hair 926b can be used to indicate and/or label a location on the landscape 900b. In some examples, the cross-hair 926b can have three intersecting lines, each representing one of the axes of the landscape 900b. In some instances, a label 928b (e.g., “CL_{—}025_{—}24-08-2010”) that is associated with the cross-hair 926b can identify the position of the cross-hair 926b relative to the landscape 900b. In this example, a portion of the label 928b (e.g., “025”) can indicate the 25^{th} month, corresponding to the time-series 912b (e.g., for twenty-five months on the second axis 904b). Similarly, the “24-08-2010” portion of the label 928b can indicate the corresponding date (i.e., representing Aug. 24, 2010) on the first axis 902b, at location 908b. In some implementations, users can use the information displayed in the landscape 902b to identify optimum underlier volatility positions. This is possible because the landscape 902b includes and displays information in a way that that provides a backward look across a large number of contracts, providing a historical context of implied volatilities looking backward from present day.

Referring to FIG. 9C, the values presented in the example three-dimensional landscape 900c, for example, are contract historical volatility values. In some implementations, futures/options traders can use the information gleened from the landscape 900c to identify optimum underlier volatility positions. This is because, when the values are presented in three dimensions within the landscape 900c, futures/options traders, for example, can look backwards across a large number of contracts and determine the historical context of the historical volatility relative to the present day. Other example three-dimensional landscapes can include comparisons and ratios of implied to historical volatility.

Referring to FIG. 9D, the values presented in the example three-dimensional landscape 900d, for example, are volume and open interest. The landscape 900d, for example, shows the “spikiness” of crude oil contract purchases and trades the closer they get to expiration. This information can be useful to traders attempting to identify the best time to enter or exit from a contract position. This is because, by reviewing the three-dimensional display in the landscape 900d, traders can make concrete estimates of available liquidity based upon historical context.

In some implementations, other three-dimensional landscapes, such as business-related landscapes, can be used to display series-based business intelligence information. For example, the business-related landscapes can be similar to the landscapes 900a-900d described earlier with reference to FIGS. 9A-9D, however the business-related landscapes can present business-related information that may or may not be related to financial instruments. For example, the business-related landscapes can be related to energy, commodities, or other products or services that follow a supply-and-demand model.

In some instances, the business-related landscapes can be based on data points collected from real-world businesses and/or public entities. The data points can include one or more business intelligence metrics, based on observed (or historical) values, e.g., prices, quantities, product grades, inventory, or other variables. The data points can be related in various ways, such as the business intelligence metrics listed, as well as geographic region, time, cost, etc. As described above for the landscapes 900a-900d, three-dimensional business-related landscapes can be generated using arrays of data points, using discrete values that can be used to generate discrete graphical elements having a visual attribute that represents the observed value for one of the data points. For example, if the business-related landscape is related to electricity prices, then a series of data points (e.g., for a geographic region) can include an individual data point for each day. Further, the first (e.g., latitudinal) dimension of the business-related landscape can correspond to time, e.g., days, weeks, months, years. In some examples, time points can represent time periods shorter than a day, such as time points that are an hour, e.g., that represent electricity supply and/or demand for each hour of a day. In some implementations, time points that are shorter (or longer) than an hour can be used.

In some instances, each of the data points in each series can correspond to one of a plurality of geographic points, and the first (e.g., latitudinal) dimension can correspond to a range of geographic points that includes the plurality of geographic points. For example, geographic points can be cities, counties or regions. In some cases, geographic points can include sub-cells in or larger cells, where the larger cells can be regions in a city, county, state/province, or country. In some examples, data points in business-related landscapes can include a geographic element and a time element. For example, a business-related landscape can be related to energy demand, and different series of data points for the business-related landscape can correspond to a plurality of geographical regions (e.g., power generation zones), and the data points within each series can correspond to different time point (e.g., days of the week, or days/weeks/months throughout the year).

Some implementations provide business-related landscapes that include data points based on energy demand based on geographical regions and time. For example, one dimension of an energy-related landscape can be a series of time points, such as hours, days, weeks, or some other time increments. Further, a second (e.g., longitudinal) dimension of an energy-related landscape can be based on geographic region, so that a series of energy-related data points can be displayed in a series for a certain city, state, power generation zones, energy sectors, or other area. In some cases, an energy-related landscape can be used to compare and contrast energy demand for multiple regions at the same time, over the same time periods. In some instances, an energy-related landscape can be used to display energy consumption by geographical region and by time. In some implementations, an energy-related landscape can be used to display energy supply by geographical region and by time. When energy data is presented using landscapes in this way, the buildings that are displayed in the landscape can have a height, color or other visible indicator that indicates the value of the data point (e.g., numbers of Kilowatt hours, megawatt hours, etc.).

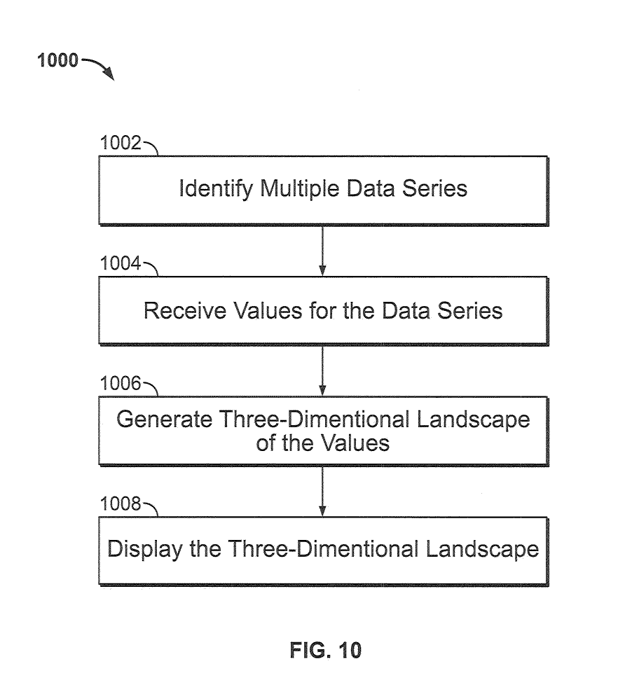

FIG. 10 is a flow chart showing an example process 1000 for generating a three-dimensional landscape of information in series format. The example process 1000 can be implemented by a computer system, for example, by one or more components of the example computing environment 100 of FIG. 1. Some or all aspects of the process 1000 may be executed at one or more client devices, at one or more server devices, or at a combination of server and client devices. The process 1000 may include additional or fewer operations performed in the order shown or in a different order. In some implementations, one or more of the operations in the process 1000 is iterated or repeated, as appropriate. In some examples, the process 1000 provides a graphical display of financial or business metric data such as, for example, a graphical display of any of the three-dimensional landscapes shown in FIGS. 9A-9D or another type of three-dimensional landscape.

At 1002, multiple data series are identified. The data series may relate to financial instruments (equities, contracts, debts, etc.), business intelligence metrics, or other objects. Each data series includes multiple ordered data points. The data points may be ordered according to time, a geographic location, or other types of parameters.

At 1004, values for each data series are received. The data may include observed market values relating to one or more financial instruments, values for business intelligence metrics, and/or other values. For example, referring to FIG. 9A, the observed market values received can be spread-to-front values that can be used to generate the three-dimensional landscape 900a. In some implementations, the observed market values can be received through a network interface, such as in real time and through sending compressed text over the Internet using HTTP or HTTPS. In some cases, the observed market values can be received on a scheduled basis, such as updating automatically every one, five or ten minutes. In some examples, automatic updates can be scheduled more frequently than that, such as just before market close and/or just after the market opens.

At 1006, a three-dimensional landscape is generated using the observed market values. As an example, a (and/or a processor at the server) can generate the three-dimensional landscape 900a related to spread-to-front values. The server 120 can transmit the three-dimensional landscape 900a (or other landscapes 900b-900d) over the data network 114 to one or more of the clients 104 for display to the user.

In the three-dimensional landscape, arrays of discrete graphical elements represent the plurality of series of data points. For example, referring to FIG. 9A, one of the arrays of discrete graphical elements that is generated can be the time-series 912a representing the three-month options for the range of dates identified on the latitudinal axis 902a. For each of the discrete graphical elements, a visual attribute represents the value for one of the data points. For example, referring to FIG. 9A, visible attributes for the discrete graphical elements in the time-series 912a can include the height of each building, reflecting the spread-to-front value of that particular discrete graphical element, and the color or shading of the building, which can represent an implied volatility value or another value. Other visual attributes can be used, such as the texture, footprint, or other visible aspect of the building that can have semantic meaning to the user who is viewing the landscape 900a. In some implementations, the semantic meaning of most or all of the visual attributes used in landscapes can be consistent across the different types of landscapes 900a-900d.

The discrete graphical elements in each array are distributed along a first dimension of the three-dimensional landscape. Each of the discrete graphical elements is positioned adjacent its neighboring element(s) in the array to allow visual identification of trends within the series represented by the array. As an example, each of the individual buildings in the time-series 912a can be displayed, side-by-side, for each of the dates in the range of dates identified on the latitudinal axis 902a. Along the latitudinal axis 902a, each of the individual buildings in the time-series 912a is displayed between (and adjacent to) the buildings representing the date points for the previous and next dates. The arrays are spaced apart from each other in a second dimension of the three-dimensional landscape to allow visual comparison of the trends across the plurality of series represented by the arrays. For example, each successive pair of time-series (e.g., time-series 912a) that is plotted along the longitudinal axis 904a can be spaced apart by a visual distance that enables the information contained in the landscape 900a to be presented in an easy-to-comprehend way. In some implementations, spacing of successive pairs of time-series can change depending on how the user tilts the display. In some implementations, user controls allow the user to increase or decrease the spacing.

The preceding figures and accompanying description illustrate example techniques and configurations. This disclosure contemplates using or implementing any suitable method for performing these and other tasks. That these flows are for illustration purposes only and the described or similar techniques may be performed at any appropriate time, including concurrently, individually, or in combination. In addition, many of the steps in these techniques may take place simultaneously and/or in different orders than as shown. Moreover, systems and software may use or implement methods with additional steps, fewer steps, and/or different steps, so long as the methods remain appropriate. In short, although this disclosure has been described in terms of certain embodiments and generally associated methods, alterations and permutations of these embodiments and methods will be apparent to those skilled in the art. Accordingly, the above description of example embodiments does not define or constrain the disclosure. Other changes, substitutions, and alterations are also possible without departing from the spirit and scope of this disclosure, and such changes, substitutions, and alterations may be included within the scope of the disclosure.

What is claimed is:

1. A computer-implemented method for generating a three-dimensional landscape of series-based financial information for presentation on a display, the method comprising:
receiving through a network interface observed market values for a plurality of series of data points, the data points relating to one or more financial instruments; and
using a data processor to generate a three-dimensional landscape of the observed market values, the three-dimensional landscape including a plurality of arrays of discrete graphical elements representing the plurality of series of data points, each of the discrete graphical elements having a visual attribute that represents the observed market value for one of the data points;
the discrete graphical elements in each array distributed along a first dimension of the three-dimensional landscape, each of the discrete graphical elements positioned adjacent to one or more neighboring discrete graphical elements in the array to allow visual identification of trends within the series represented by the array, the arrays spaced apart from each other in a second dimension of the three-dimensional landscape to allow visual comparison of the trends across the plurality of series represented by the arrays.

2. The method of claim 1, each of the data points in each series corresponds to one of a plurality of time points, and the first dimension corresponds to a range of time points that includes the plurality of time points.

3. The method of claim 2, each series of data points spans the range of time points.

4. The method of claim 2, each of the discrete graphical elements positioned adjacent to one or more neighboring discrete graphical elements in the array to allow visual identification of trends over time within the series, the arrays spaced apart from each other in a second dimension of the three-dimensional landscape to allow visual comparison of the trends over time across the plurality of series.

5. The method of claim 1, the observed market value for each data point is based on an end-of-day closing price for at least one of a financial contract, an equity security, or a debt instrument.

6. The method of claim 1, the observed market value for each data point is based on an intraday price for at least one of a financial contract, an equity security, or a debt instrument.

7. The method of claim 1, each series represents a time-based metric for at least one of a financial contract, an equity security or a debt instrument.

8. The method of claim 1, each array of discrete graphical elements includes an array of buildings, a height of each building represents the observed market value for one of the data points.

9. The method of claim 8, the three-dimensional landscape includes:
a longitudinal dimension representing a plurality of forward month values;
a latitudinal dimension representing a plurality of time points; and
a vertical dimension representing a range of observed market values;
a location of each building in the longitudinal and latitudinal dimensions indicates a forward month value and a time point for the data point represented by the building;
a height of each building in the vertical dimension indicates the observed market value for the data point represented by the building; and
a footprint of each building indicates a second observed market value for the data point represented by the building.

10. The method of claim 9, the second observed market value comprising at least one of a trading volume or a deviation from average trading volume.

11. The method of claim 9, each of the buildings having a color that indicates a third observed market value for the data point represented by the building.

12. The method of claim 1, the observed market value comprising at least one of a price value, an implied volatility value, a bid value, an ask value, a mid value, a delta value, a vega value, a gamma value, a theta value, a rho value, or an implied interest rate yield value.

13. The method of claim 1, the observed market value comprising a ratio based on at least one of a price value, an implied volatility value, a bid value, an ask value, a mid value, a delta value, a vega value, a gamma value, a theta value, a rho value, or an implied interest rate yield value.

14. The method of claim 1, each series of data points relating to a single financial instrument, the single financial instrument comprising a financial contract, an equity security, or a debt instrument.

15. The method of claim 14, the financial contract comprising at least one of a futures contract, a derivatives contract, or a swap contract.

16. An article comprising a computer-readable medium storing instructions for generating a three-dimensional landscape of series-based financial information, the instructions operable when executed by data processing apparatus to perform operations comprising:
receiving through a network interface observed market values for a plurality of series of data points, the data points relating to one or more financial instruments; and
generating a three-dimensional landscape of the observed market values, the three-dimensional landscape including a plurality of arrays of discrete graphical elements representing the plurality of series of data points, each of the discrete graphical elements having a visual attribute that represents the observed market value for one of the data points;
the discrete graphical elements in each array distributed along a first dimension of the three-dimensional landscape, each of the discrete graphical elements positioned adjacent to one or more neighboring discrete graphical elements in the array to allow visual identification of trends within the series represented by the array, the arrays spaced apart from each other in a second dimension of the three-dimensional landscape to allow visual comparison of the trends across the plurality of series represented by the arrays.

17. The article of claim 16, identifying observed market values includes downloading the observed market values in real time.

18. The article of claim 16, downloading the observed market values in real time includes sending compressed text over HTTP or HTTPS.

19. The article of claim 16, each array of discrete graphical elements includes an array of buildings, a height of each building represents the observed market value for one of the data points.

20. The article of claim 16, the operations further comprising displaying the three-dimensional landscape.

21. A system for generating a three-dimensional landscape of financial information, the system comprising:
a database storing observed market values for a plurality of series of data points, the data points relating to one or more financial instruments; and
a server operable to generate a three-dimensional landscape of the observed market values, the three-dimensional landscape including a plurality of arrays of discrete graphical elements representing the plurality of series of data points, each of the discrete graphical elements having a visual attribute that represents the observed market value for one of the data points;
the discrete graphical elements in each array distributed along a first dimension of the three-dimensional landscape, each of the discrete graphical elements positioned adjacent to one or more neighboring discrete graphical elements in the array to allow visual identification of trends within the series represented by the array, the arrays spaced apart from each other in a second dimension of the three-dimensional landscape to allow visual comparison of the trends across the plurality of series represented by the arrays.

22. The system of claim 21, the server further operable to generate an updated version of the three-dimensional landscape based on updates for the observed market values.

23. The system of claim 21, further comprising a data network interface, the server further operable to receive the observed market values from a remote source through the data network interface.

24. The system of claim 21, the server further operable to transmit the three-dimensional landscape over a data network to a client device for display to a user.

25. A computer-implemented method for generating a three-dimensional landscape of series-based business intelligence information, the method comprising:
receiving through a network interface observed values for a plurality of series of data points, the data points relating to one or more business intelligence metrics; and
using a data processor to generate a three-dimensional landscape of the observed values, the three-dimensional landscape including a plurality of arrays of discrete graphical elements representing the plurality of series of data points, each of the discrete graphical elements having a visual attribute that represents the observed value for one of the data points;
the discrete graphical elements in each array distributed along a first dimension of the three-dimensional landscape, each of the discrete graphical elements positioned adjacent to one or more neighboring discrete graphical elements in the array to allow visual identification of trends within the series represented by the array, the arrays spaced apart from each other in a second dimension of the three-dimensional landscape to allow visual comparison of the trends across the plurality of series represented by the arrays.

26. The method of claim 25, each of the data points in each series corresponds to one of a plurality of time points, and the first dimension corresponds to a range of time points that includes the plurality of time points.

27. The method of claim 25, each of the data points in each series corresponds to one of a plurality of geographic points, and the first dimension corresponds to a range of geographic points that includes the plurality of geographic points.

28. The method of claim 25, at least a portion of the data points based on energy demand, the plurality of series corresponding to a plurality of geographical regions, the data points within each series corresponding to different time points.

29. The method of claim 25, at least a portion of the data points based on energy consumption, the plurality of series corresponding to a plurality of geographical regions, the data points within each series corresponding to different time points.

30. The method of claim 25, the arrays of discrete graphical elements including arrays of buildings, each building having a height that indicates one of the received values.

31. The method of claim 25, the data points based on at least one of energy demand or energy consumption for an energy sector.
